(19) United States
(12) Patent Application Publication
(10) Pub. No.: US 2026/0269934 A1
(43) Pub. Date: Sep. 10, 2026

(54) MANAGING SATELLITE COMMUNICATION USING STORE AND FORWARD SERVICE WITH NETWORK NODE ONBOARDING SATELLITE

(71) Applicant: SAMSUNG ELECTRONICS CO., LTD., Suwon-si (KR)

(72) Inventors: Dinesh Rooparam CHOUDHARY, Bangalore (IN); Lalith KUMAR, Bangalore (IN); Aman AGARWAL, Bangalore (IN); Sidhant JAIN, Bangalore (IN); Utsav SINHA, Bangalore (IN)

(21) Appl. No.: 19/663,012

(22) Filed: Apr. 29, 2026

Related U.S. Application Data
(63) Continuation of application No. PCT/KR2024/017151, filed on Nov. 4, 2024.

(30) Foreign Application Priority Data
Nov. 2, 2023 (IN) 202341074938
Oct. 24, 2024 (IN) 202341074938

(51) Int. Cl. H04B 7/185; H04W 4/14

(52) U.S. Cl. CPC H04B 7/18539; H04B 7/18554; H04W 4/14

(57) ABSTRACT

Methods and systems for managing satellite communication using a store and forward (S&F) service with at least one network node onboarding a satellite are disclosed. The method includes determining, by a User Equipment (UE), that a network supports the S&F service; determining, by the UE, at least one new value of a timer and provide the estimated delivery time to upper layers of the UE, to use the at least one new value of the timer by an application layer based on at least one estimated delivery time received from a core network node (600; and initiating, by the UE, at least one Non-Access Stratum (NAS) procedure with the network based on the determined at least one new value of the timer.

### CROSS-REFERENCE TO RELATED APPLICATIONS

This application is a continuation of International Application No. PCT/KR2024/017151 designating the United States, filed on Nov. 4, 2024, in the Korean Intellectual Property Receiving Office and claiming priority to Indian Provisional Patent Application No. 202341074938, filed on Nov. 2, 2023, and Indian Complete patent application Ser. No. 202341074938, filed on Oct. 24, 2024, the disclosures of each of which are incorporated by reference herein in their entireties.

### BACKGROUND

### Field

The disclosure relates to satellite communications, and for example, to providing estimated delivery time to a User Equipment (UE) in a satellite communication network with at least one Network Function (NF) onboard the satellite using a store and forward operation.

### Description of Related Art

Currently, in the Fifth Generation (5G) network, the store and forward satellite operations may provide communication services to a User Equipment (UE). The communication services may comprise the satellite coverage with intermittent or temporary satellite connectivity (e.g., when the satellite is not connected through a feeder link or through Inter-Satellite Link (ISL) to the ground network or when both the service link and the feeder link are not available) for delay-tolerant communication service.

In existing terrestrial networks, the core network entities or the Network Functions (NFs) may be connected to each other. Because of the interconnected nature, the procedures between the UE and the network, as well as between different network functions or entities, can be conducted seamlessly without any significant delay.

In store and forward (S&F) operations, the link between the UE and the satellite (service link) and the link between the satellite and the ground station (feeder link) are not connected at the same time. Thus, any procedure, such as attach/registration, which requires interaction between the UE and the ground station, needs to be modified to account for the non-availability of the feeder link and service link at the same point in time.

Therefore, the communication procedures between the UE and the network are defined for terrestrial networks, wherein the response can be received from the network entities within a very short time period. When the satellite network is operating in store and forward mode (e.g., the feeder link is not available) and it does not have the UE context or subscription information, the UE cannot attach/register with the satellite and perform communication.

### SUMMARY

According to an example embodiment, a method for managing satellite communication using a store and forward (S&F) service with at least one network node onboard the satellite is provided. The method may include determining, by a User Equipment (UE), that a network supports the store and forward service; initiating, by the UE, at least one Non-Access Stratum (NAS) procedure with the network, where the UE determines at least one new value of a timer; and providing the estimated delivery time to upper layers in the UE to use it at application layer based on at least one estimated delivery time received from a core network node.

According to an example embodiment, a method for managing satellite communication is provided. The method may include: determining, by a core network node, that at least one NAS procedure initiated by a UE cannot be completed due to at least one store and forward (S&F) operation wherein a mobility management entity (MME) does not have UE security context or, based on the MME needing to retrieve UE-specific authentication vectors or subscription information from the ground network, wherein the core network node is onboard the network; and providing, by the core network node, at least one estimated delivery time to the UE, wherein the estimated delivery time is the minimum time for the data and signaling to reach a ground station.

According to an example embodiment of the disclosure, a system for managing satellite using a store and forward (S&F) service with at least one network node onboard the satellite is provided. The system may include: at least one processor, comprising processing circuitry, and a memory, wherein at least one processor, individually and/or collectively, is configured to cause the system to: determine that a network supports the store and forward service; initiate at least one Non-Access Stratum (NAS) procedure with the network, wherein the UE determines at least one new value of a timer; and provide the estimated delivery time to upper layers in the UE to use it at application layer based on at least one estimated delivery time received from a core network node.

According to an example embodiment of the disclosure, a system for managing satellite is provided. The system may include: at least one processor, comprising processing circuitry, and a memory, wherein at least one processor, individually and/or collectively, is configured to cause the system to: determine that at least one Non-Access Stratum (NAS) procedure initiated by a User Equipment (UE) cannot be completed due to at least one store and forward (S&F) operation, wherein the core network node cannot complete the procedure with the information currently available on the satellite when the MME does not have UE security context or, based on the MME needing to retrieve UE-specific authentication vectors or subscription information from the ground network, wherein the core network node is onboard the network; and provide at least one estimated delivery time to the UE, the estimated delivery time being the minimum time for the data and signaling to reach a ground station.

According to an example embodiment of the disclosure, a method performed by a user equipment (UE) for managing satellite communication using a store and forward (S&F) service with a core network node onboarding a satellite is provided. The method comprises: transmitting a request message to the core network node; and receiving an accept message as a response of the request message from the core network node, the accept message including information on an estimated delivery time for data to reach a ground station from the UE; and performing a communication based on the estimated delivery time.

According to an example embodiment of the disclosure, a method performed by a core network node onboarding a satellite is provided. The method comprises: receiving a request message from a user equipment (UE); and transmitting an accept message to the UE. The accept message includes information on an estimated delivery time for data to reach a ground station from the UE in accordance with at least one store and forward (S&F) operation.

According to example embodiment of the disclosure, a user equipment (UE) for managing satellite communication using a store and forward (S&F) service with a core network node onboard the satellite is provided. The UE comprises: at least one processor comprising processing circuitry; and memory storing instructions, wherein at least one processor, individually and/or collectively, is configured to execute the instructions and to cause the UE to: transmit a request message to the core network node; receive an accept message as a response of the request message from the core network node, the accept message including information on an estimated delivery time for data to reach a ground station from the UE; and perform a communication based on the estimated delivery time.

According to an example embodiment of the disclosure, a core network node onboarding a satellite is provided. The core network node comprises: at least one processor comprising processing circuitry; memory storing instructions, wherein at least one processor, individually and/or collectively, is configured to execute the instructions and to cause the core network node to: receive a request message from a user equipment (UE); and transmit an accept message to the UE, wherein the accept message includes information on an estimated delivery time for data to reach a ground station from the UE in accordance with at least one store and forward (S&F) operation.

The estimated delivery time is the minimum time for the data and signaling to reach a ground station. The term reach the ground station implies that the signaling/data to reach the ground network which can be at least one core network node like mobility management entity (MME), access and mobility management function (AMF), session management function (SMF), user plane function (UPF), serving-gateway (S-GW), packet data network (PDN)-gateway (P-GW), service capability exposure function (SCEF), data network (DN) etc or it can be at least one application server or application function.

These and other aspects of the various example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made herein without departing from the spirit of the disclosure, and the disclosure and embodiments herein include all such modifications.

### BRIEF DESCRIPTION OF THE DRAWINGS

Various example embodiments are illustrated in the accompanying drawings, throughout which like reference letters indicate corresponding parts in the various figures. The above and other aspects, features and advantages of certain embodiments of the present disclosure will be more apparent from the following detailed description, taken in conjunction with the accompanying drawings, in which:

FIG. 1A is a diagram illustrating example movement of a satellite around the Earth at various times, wherein a user equipment (UE) is configured to be served by the satellite, according to the prior art;

FIGS. 1B and 1C are diagrams illustrating an example store and forward operation performed by the satellite, the UE, and a ground network in the satellite communication, according to the prior art;

FIG. 2 is a diagram illustrating an example scenario in which the feeder link is not available while performing the S&F operation performed by the satellite, according to prior art;

FIG. 3 is a diagram illustrating an example scenario wherein the estimated delivery time is provided to the UE in the S&F service, wherein the UE determines a new value of the timer, according to various embodiments;

FIG. 4 is a block diagram illustrating example configurations and interactions of the satellite with the UE and a core network node in the satellite communication, according to various embodiments;

FIG. 5 is a signal flow diagram illustrating an example process of managing satellite communication using the S&F service with at least one network node onboarding the satellite and the UE, according to various embodiments;

FIG. 6 is a diagram illustrating an example architecture of the satellite with the feeder link and a service link available while interacting with the core network node, according to various embodiments;

FIGS. 7A, 7B, and 7C are diagrams illustrating example scenarios of the network node interacting with the UE at various time T0, T1, and T2 respectively, according to various embodiments; and

FIG. 8 is a signal flow diagram illustrating an example process of establishing a link between the UE and the satellite, according to various embodiments.

### DETAILED DESCRIPTION

Various example embodiments herein and the various features and advantageous details thereof are explained more fully with reference to the non-limiting example embodiments that are illustrated in the accompanying drawings and detailed in the following description. Descriptions of well-known components and processing techniques may be omitted so as to not unnecessarily obscure the disclosure. The examples used herein are intended merely to facilitate an understanding of ways in which the disclosure can be practiced. Accordingly, the examples should not be construed as limiting the scope of the disclosure.

For the purposes of interpreting this disclosure, the definitions (as defined herein) will apply and whenever appropriate the terms used in singular will also include the plural and vice versa. It is to be understood that the terminology used herein is for the purposes of describing various embodiments and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to refer, for example, to “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Various example embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. The blocks of various embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the various embodiments as disclosed herein. In terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. In terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the various embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

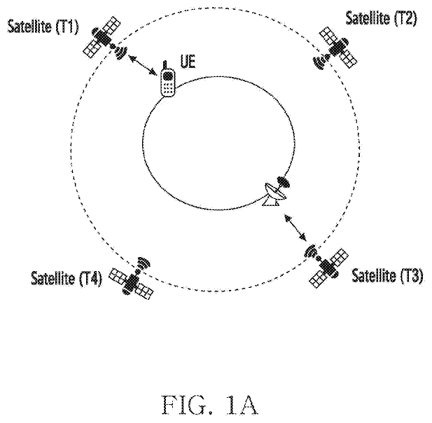

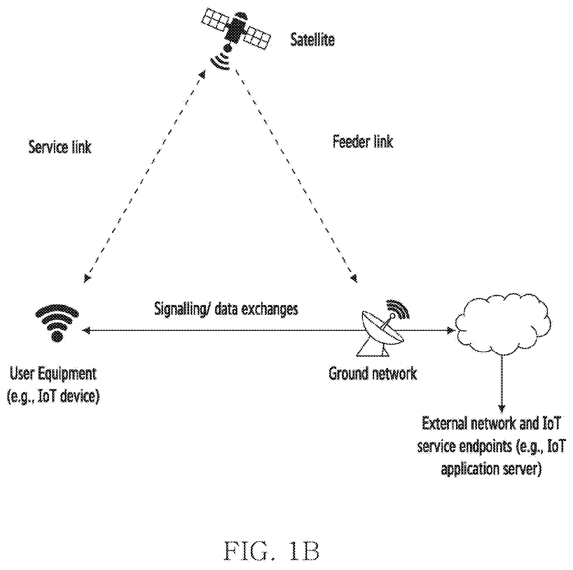

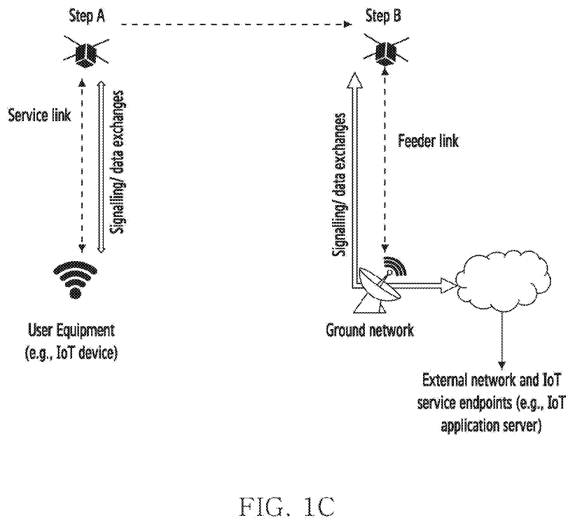

An example of “S&F Satellite operation” is illustrated in FIGS. 1A and 1B. Under “normal/default Satellite operation” mode, signalling and data traffic exchange between a UE with satellite access and the remote ground network requires the service and feeder links to be active simultaneously, so that, at the time that the UE interacts over the service link with the satellite, there is a continuous end-to-end connectivity path between the UE, the satellite and the ground network. Under “S&F Satellite operation” mode, the end-to-end exchange of signalling/data traffic is now handled as a combination of two steps not concurrent in time (Steps A and B). In Step A, signalling/data exchange between the UE and the satellite takes place, without the satellite being simultaneously connected to the ground network (e.g., the satellite is able to operate the service link without an active feeder link connection). In Step B, connectivity between the satellite and the ground network is established so that communication between the satellite and the ground network can take place. So, the satellite moves from being connected to the UE in step A to being connected to the ground network in step B.

FIG. 1A is a diagram illustrating the movement of the satellite around the Earth at various times according to the prior art. In the existing mechanism, using S&F operation, when the UE sends a Non-Access Stratum (NAS) message, the UE starts a timer, expecting a response from the network. The network cannot respond immediately because it must interact with a Core Network (CN) node, which may occur, after a specific time period (for example after six hours). The timer on the UE, waiting for the response, will expire, and the UE may initiate an error recovery procedure due to the expiration of the timer(s). Additionally, the time to reach the ground station can vary based on the location of the UE, the number of satellites deployed, and the location of the ground station relative to the current location of the UE. Therefore, the UE cannot determine the estimated delivery time.

The application on the UE is not aware about the time, it may take for the data/signaling to be delivered to the destination application server. For instance, if an application layer packet is sent expecting a response within a maximum of ten seconds (as in normal terrestrial networks), the timers on the UE will expire, leading the UE to perform error recovery procedures.

The concept of “S&F” service is widely used in the fields of delay-tolerant networking and disruption-tolerant networking. In 3rd generation partnership project (3GPP) context, a service that could be assimilated to an S&F service is SMS, for which there is no need to have an end-to-end connectivity between the endpoints (e.g., an endpoint can be a UE and the other an application server) but only between the end-points and the SMSC which acts as an intermediate node in charge of storing and relying.

The support of S&F Satellite operation is suited for the delivery of delay-tolerant/non-real-time IoT satellite services with non-geostationary satellite orbit (NGSO) satellites.

The CN node, may include but are not limited to a Home Subscriber Server (HSS), a Next Generation Node B (gNB), an Access Mobility Management Function (AMF), a Mobility Management Entity (MME), a Serving Gateway (S-GW), a User Plane Function (UPF), a Policy Control Function (PCF), a Network Exposure Function (NEF), and a Proxy Data Network (Proxy-DN).

Existing mechanisms do not enable the satellite to store UE context and information so that the procedures can be executed. For delay-tolerant UEs, it may not be necessary to provide continuous services to the UE as long as service can be provided periodically. Therefore, it may not be required for all satellites to store all UEs' contexts or for all satellites to provide services to all UEs. Currently, there does not exist and method to restrict the UEs from attempting to access all satellites, that are providing service in the area of the UE. Thus, the UE may try to access satellites that do not have its context and subscription information and therefore may not be able to provide service to the UE(s).

For example, the store and forward satellite operation as illustrated in FIG. 1B, is a diagram illustrating the normal/default satellite operation used in 5G network with the satellite access according to the prior art. As illustrated in FIG. 1B, under normal/default satellite operation, the signaling and data traffic exchange between the UE with satellite access and the remote ground network requires a service and feeder links to be active simultaneously. Hence, the UE can interact with the service link of the satellite, establish a continuous connectivity path between the UE, the satellite, and the ground network. As illustrated in FIG. 1C, using the store and forward satellite operation, the exchange of signaling/data traffic can be handled in two non-concurrent steps. In step A, signalling/data is exchanged between the UE and the satellite, without the satellite being simultaneously connected to the ground network (e.g., the satellite is able to operate the service link without an active feeder link connection). In step B, connectivity between the satellite and the ground network is established, so that the satellite can communicate with the ground network. Hence, the satellite moves from being connected to the UE in step A to being connected to the ground network in step B.

The store and forward operation can be used for delay-tolerant/non-real-time Internet of Things (IoT) satellite services with Non-Geostationary Satellite Orbit (NGSO) satellites. Information related to satellite coverage availability can be provided to the UE through a Protocol Data Unit (PDU) session or SMS.

The UEs may support store and forward operation, connected through the satellite access to the satellite. The architectural changes are required to support store and forward operations in 4G/5G network services using satellite access, which is currently not defined.

As illustrated in FIG. 1C, the UE may register with the static MME of the network, resulting in a one-to-one relationship. The static MME can manage the UE context on the network, allowing the UE to access services.

For S&F operation, when the UE sends the NAS message, it starts a timer, expecting a response from the network. However, the network cannot respond immediately because it must interact with core network nodes (e.g., HSS), which may take, for example, up to six hours. During this time, the timer on the UE, which is waiting for the response, will expire, and the UE may initiate an error recovery procedure due to the expiration of the timer(s). The time to reach the ground station can vary widely based on the location of the UE, the number of satellites deployed, and the distance of the ground station relative to the current position of the UE. Therefore, the UE cannot determine the estimated delivery time.

The application on the UE is not aware of the time, it may take for the data/signaling to be delivered to the destination application server. For instance, if an application layer packet is sent expecting a response within a maximum of ten seconds (as in normal terrestrial networks), the timers on the UE will expire, leading the UE to perform error recovery procedures.

Hence, the UE is not aware of the time it may take between step A and step B as illustrated in FIG. 1C. The time widely depends on the location of the UE, the number of satellites deployed, and the distance of the ground station relative to the current location of the UE.

Table 1 illustrates 5GC mobility management timers at the UE side.

TABLE 1

| TIMER | TIMER | | CAUSE OF | | ON |
|---|---|---|---|---|---|
| NUM. | VALUE | STATE | START | NORMAL STOP | EXPIRY |
| T3502 | Default 12 | 5GMM-DEREGISTERED | At registration | Transmission of | Initiation of the |
| | min. | 5GMM-REGISTERED | failure and the | REGISTRATION | registration |
| | NOTE 1 | | attempt counter | REQUEST message | procedure, if |
| | | | is equal to 5 | | still required |
| T3510 | 15 s | 5GMM-REGISTERED- | Transmission of | REGISTRATION | Start T3511 or |
| | NOTE 7 | INITIATED | REGISTRATION | ACCEPT message | T3502 as |
| | NOTE 8 | | REQUEST | received | specified in |
| | In WB- | | message | REGISTRATION | subclause 5.5.12.7 |
| | N1/CE | | | REJECT message | if T3510 |
| | mode, 85 s | | | received | expired during |
| | For access | | | | registration |
| | via a | | | | procedure for |
| | satellite | | | | initial |
| | NG-RAN | | | | registration. |
| | cell, 27 s | | | | Start T3511 or |
| | NOTE 12 | | | | T3502 as |
| | | | | | specified in |
| | | | | | subclause 5.5.1.3.7 |
| | | | | | if T3510 |
| | | | | | expired during |
| | | | | | the registration |
| | | | | | procedure for |
| | | | | | mobility and |
| | | | | | periodic |
| | | | | | registration |
| | | | | | update |
| T3511 | 10 s | 5GMM- | At registration | Transmission | Retransmission |
| | | DEREGISTERED.ATTEMPT- | failure due to | REGISTRATION | of the |
| | | ING-REGISTRATION | lower layer | REQUEST message | REGISTRATION |
| | | 5GMM- | failure, T3510 | 5GMM- | REQUEST |
| | | REGISTERED.ATTEMPT- | timeout or | CONNECTED | message, if still |
| | | ING-REGISTRATION- | registration | mode entered | required |
| | | UPDATE | rejected with | (NOTE 5) | |
| | | 5GMM- | other 5GMM | | |
| | | REGISTERED.NORMAL- | cause values | | |
| | | SERVICE or 5GMM- | than those | | |
| | | REGISTERED.NON- | treated in | | |
| | | ALLOWED-SERVICE | subclause 5.5.1. | | |
| | | | 2.5 for initial | | |
| | | | registration or | | |
| | | | subclause 5.5.1. | | |
| | | | 3.5 for mobility | | |
| | | | and periodic | | |
| | | | registration | | |
| T3512 | Default 54 | 5GMM-REGISTERED | In 5GMM- | When entering state | In 5GMM- |
| | min | | REGISTERED, | 5GMM- | IDLE mode, |
| | NOTE 1 | | when 5GMM- | DEREGISTERED | Initiation of the |
| | NOTE 2 | | CONNECTED | When entering | periodic |
| | | | mode is left and | 5GMM- | registration |
| | | | if the NW does | CONNECTED | procedure if the |
| | | | not indicate | mode if the NW | UE is not |
| | | | support for | does not indicte | registered for |
| | | | strictly periodic | support for strictly | emergency |
| | | | registration | periodic registration | services. |
| | | | timer | timer as specified in | In 5GMM- |
| | | | specified in | subclause 5.3.7. | CONNECTED |
| | | | subclause 5.3.7. | | mode, restart |
| | | | If the network | | the timer |
| | | | indicates | | T3512. |
| | | | support for | | Locally |
| | | | strictly periodic | | deregister if the |
| | | | registration | | UE is |
| | | | timer, T3512 is | | registered for |
| | | | started after the | | emergency |
| | | | successful | | services |
| | | | completion of | | |
| | | | registration | | |
| | | | update | | |
| | | | procedure. | | |
| | | | T3512 is | | |
| | | | restarted if it | | |
| | | | expires in | | |
| | | | 5GMM- | | |
| | | | CONNECTED | | |
| | | | mode as | | |
| | | | specified in | | |
| | | | subclause 5.3.7. | | |
| T3516 | 30 s | 5GMM-REGISTERED- | RAND and | SECURITY MODE | Delete |
| | NOTE 7 | INITIATED | RES* stored as a | COMMAND | the |
| | NOTE 8 | 5GMM-REGISTERED | result of an 5G | message received | stored RAND |
| | In WB- | 5GMM- | authentication | SERVICE REJECT | and RES* |
| | N1/CE | DEREGISTERED- | challenge | message received | |
| | mode, 48 s | INITIATED | | REGISTRATION | |
| | For access | 5GMM-SERVICE- | | ACCEPT message | |
| | via a | REQUEST-INITIATED | | received | |
| | satellite | | | AUTHENTICATION | |
| | NG-RAN | | | REJECT message | |
| | cell, 35s | | | received | |
| | NOTE 12 | | | AUTHENTICATION | |
| | | | | FAILURE | |
| | | | | message sent | |
| | | | | 5GMM- | |
| | | | | DEREGISTERED, | |
| | | | | 5GMM-NULL or | |
| | | | | 5GMM-IDLE mode | |
| | | | | entered | |
| T3517 | 5 s for case | 5GMM-SERVICE- | Transmission of | Indication from the | Abort the |
| | h) in | REQUEST-INITIATED | SERVICE | lower layers that the | procedure |
| | subclause | | REQUEST | UE has changed to | |
| | 5.6.1.1; or | | message, or | S1 mode or E- | |
| | 15 s for | | CONTROL | UTRA connected to | |
| | cases other | | PLANE | 5GCN for case h) in | |
| | than h) in | | SERVICE | subclause 5.6.1.1; or | |
| | subclause | | REQUEST | SERVICE ACCEPT | |
| | 5.6.1.1 | | message | message received, or | |
| | NOTE 7 | | | SERVICE REJECT | |
| | NOTE 8 | | | message received | |
| | NOTE 10 | | | for cases other than | |
| | In WB- | | | h) in | |
| | N1/CE | | | subclause 5.6.1.1 | |
| | mode, 61 s | | | see | |
| | For access | | | subclause 5.6.1.4.2 | |
| | via a | | | | |
| | satellite | | | | |
| | NG-RAN | | | | |
| | cell, 27 s | | | | |
| | NOTE 12 | | | | |
| T3519 | 60 s | 5GMM-REGISTERED- | Transmission of | REGISTRATION | Delete stored |
| | NOTE 7 | INITIATED | IDENTITY | ACCEPT message | SUCI |
| | NOTE 8 | 5GMM-REGISTERED | RESPONSE | with new 5G-GUTI | |
| | In WB- | 5GMM- | message, | received | |
| | N1/CE | DEREGISTERED- | REGISTRATION | CONFIGURATION | |
| | mode, 90 s | INITIATED | REQUEST | UPDATE | |
| | For access | 5GMM-SERVICE- | message, or | COMMAND | |
| | via | REQUEST-INITIATED | DEREGISTRATION | message with new | |
| | satellite | (NOTE 6) | REQUEST | 5G-GUTI received | |
| | NG-RAN | | message with | DEREGISTRATION | |
| | cell, 65 s | | freshly | ACCEPT | |
| | | | generated SUCI | message | |
| T3520 | 15 s | 75GMM-REGISTERED- | Transmission of | AUTHENTICATION | ON first expiry |
| | NOTE 7 | INITIATED | AUTHENTICATION | REQUEST | during a 5G |
| | NOTE 8 | 5GMM-REGISTERED | FAILURE | message received or | AKA based |
| | In WB- | 5GMM- | message with | AUTHENTICATION | primary |
| | N1/CE | DEREGISTERED- | any of the | REJECT message | authentication |
| | mode, 33 s | aINITIATED | 5GMM cause | received | and key |
| | For access | 5GMM-SERVICE- | #20, #21, #26 or | or | agreement |
| | via a | REQUEST-INITIATED | #71 | SECURITY MODE | procedure, the |
| | satellite | | Transmission of | COMMAND | UE should |
| | NG-RAN | | AUTHENTICATION | message received | consider the |
| | cell, 20 s | | RESPONSE | when entering | network as |
| | NOTE 12 | | message with an | 5GMM-IDLE mode | false and |
| | | | EAP-response | indication of | follow item g |
| | | | message after | transmission failure | of |
| | | | detection of an | of | subclause 5.4.1.3.7, |
| | | | error as | AUTHENTICATION | if the UE |
| | | | described in | FAILURE | is not |
| | | | subclause 5.4.1.2.2.4 | message from lower | registered for |
| | | | | layers | emergency |
| | | | | | services. |
| | | | | | On first expiry |
| | | | | | during a 5G |
| | | | | | AKA based |
| | | | | | primary |
| | | | | | authentication |
| | | | | | and key |
| | | | | | agreement |
| | | | | | procedure, the |
| | | | | | UE will follow |
| | | | | | subclause 5.4.1.3.7 |
| | | | | | under “For |
| | | | | | items c, d, e |
| | | | | | and f:”, if the |
| | | | | | UE Is |
| | | | | | registered for |
| | | | | | emergency |
| | | | | | services. |
| | | | | | On first expiry |
| | | | | | during an EAP |
| | | | | | based primary |
| | | | | | authentication |
| | | | | | and key |
| | | | | | agreement |
| | | | | | procedure, the |
| | | | | | UE should |
| | | | | | consider the |
| | | | | | network as |
| | | | | | false and |
| | | | | | follow item e |
| | | | | | of |
| | | | | | subclause 5.4.1.2.4.5, |
| | | | | | if the |
| | | | | | UE is not |
| | | | | | registered for |
| | | | | | emergency |
| | | | | | services. |
| | | | | | On first expiry |
| | | | | | during an EAP |
| | | | | | based primary |
| | | | | | authentication |
| | | | | | and key |
| | | | | | agreement |
| | | | | | procedure, the |
| | | | | | UE will follow |
| | | | | | subclause |
| | | | | | 5.4.1.2.4.5 under |
| | | | | | “For item e:”, if |
| | | | | | the UE ″s |
| | | | | | registered for |
| | | | | | emergency |
| | | | | | services |
| T3521 | 15 s | 5GMM- | Transmission of | DEREGISTRATION | Retransmission |
| | NOTE 7 | DEREGISTERED- | DEREGISTRATION | ACCEPT | of |
| | NOTE 8 | INITIATED | REQUEST | message received | DEREGISTRATION |
| | In WB- | | message when | | REQUEST |
| | N1/CE | | de-registration | | message |
| | mode, 45 s | | procedure is not | | |
| | For access | | due to a “switch | | |
| | via a | | off” | | |
| | satellite | | | | |
| | NG-RAN | | | | |
| | cell, 27 s | | | | |
| | NOTE 12 | | | | |
| T3525 | Default | 5GMM- | T3517 expires | When entering state | The UE may |
| | 60 s | REGISTERED.NORMAL- | and service | other than 5GMM- | initiate service |
| | NOTE 3 | SERVICE or 5GMM- | request attempt | REGISTERED.NOR- | request |
| | NOTE 7 | REGISTERED.NON- | counter is | MAL-SERVICE | procedure |
| | NOTE 8 | ALLOWED-SERVICE | greater than or | state or 5GMM- | |
| | In WB- | | equal to 5 | REGISTERED.NON- | |
| | N1/CE | | | ALLOWED- | |
| | mode, | | | SERVICE, | |
| | default 120 s | | | or | |
| | For access | | | UE camped on a | |
| | via a | | | new PLMN other | |
| | satellite | | | than the PLMN on | |
| | NG-RAN | | | which timer started, | |
| | cell, default | | | or | |
| | 72 s | | | User-plane | |
| | NOTE 12 | | | resources | |
| | | | | established with the | |
| | | | | network | |
| T3540 | 10 s | 5GMM- | REGISTRATION | N1 NAS signalling | Release the |
| | NOTE 7 | DEREGISTERED | REJECT | connection released | NAS |
| | (applicable | 5GMM-REGISTERED | message or | PDU sessions have | signalling |
| | to case f) in | | DEREGISTRATION | been set up except | connection for |
| | subclause | | REQUEST | for the case the UE | the cases a), b), |
| | 5.3.1.3) | | message | has set Request type | f) and g) as |
| | NOTE 8 | | received with | to “NAS signalling | described in |
| | In WB- | | any of the | connection release” | subclayse 5.3.1.3 |
| | N1/CE | | 5GMM cause | in the UE request | |
| | mode, 34 s | | #3, #6, #7, #11, | type IE in the | |
| | (applicable | | #12, #13, #15, | REGISTRATION | |
| | to case f) in | | #27, #31, #62, | REQUEST message | |
| | subclause | | #72, #73, #74, | as described in | |
| | 5.3.1.3) | | #75, #76 or #78 | subclause 5.3.1.3 | |
| | NOTE 11 | | SERVICE | case b) | |
| | For access | | REJECT | Other use cases see | |
| | via a | | message | subclause 5.3.1.3 | |
| | satellite | | received with | | |
| | NG-RAN | | any of the | | |
| | cell, default | | 5GMM cause | | |
| | 22 s | | #3, #6, #7, #11, | | |
| | (applicable | | #12, #13, #15, | | |
| | to case f) in | | #27, #72, #73, | | |
| | subclause | | #74, #75, #76 or | | |
| | 5.3.1.3) | | #78. | | |
| | NOTE 12 | | REGISTRATION | | |
| | | | ACCEPT | | |
| | | | message | | |
| | | | received as | | |
| | | | described in | | |
| | | | subclause | | |
| | | | 5.3.1.3 case b) | | |
| | | | and case h) | | |
| | | | SERVICE | | |
| | | | ACCEPT | | |
| | | | message | | |
| | | | received as | | |
| | | | described in | | |
| | | | subclause 5.3.1.3 | | |
| | | | case f) | | |
| | | | AUTHENTICATION | | |
| | | | REJECT | | |
| | | | message | | |
| | | | received | | |
| | | | DEREGISTRATION | | |
| | | | ACCEPT | | |
| | | | message | | |
| | | | received as | | |
| | | | described in | | |
| | | | subclause 5.3.1.3 | | |
| | | | case k) | | |
| | | 5GMM-REGISTERED | CONFIGURATION | NI NAS signalling | Release the |
| | | | UPDATE | connection released | NAS |
| | | | COMMAND | Other use cases see | signalling |
| | | | message | subclause 5.3.1.3 | connection for |
| | | | received as | | the case e) as |
| | | | described in | | described in |
| | | | subclause 5.3.1.3 | | subclause 5.3.1.3 |
| | | | case e) and h) | | and |
| | | | SERVICE | | perform a new |
| | | | ACCEPT | | registration |
| | | | message | | procedure as |
| | | | received as | | described in |
| | | | described in | | subclause |
| | | | subclause 5.3.1.3 | | 5.5.1.3.2 |
| | | | case i) | | Release the |
| | | | | | NAS |
| | | | | | signalling |
| | | | | | connection for |
| | | | | | the case h) and |
| | | | | | i) as described |
| | | | | | in |
| | | | | | subclause 5.3.1.3 |
| | | 5GMM- | REGISTRATION | | Release the |
| | | DEREGISTERED | REJECT | | NAS |
| | | 5GMM- | message | | signalling |
| | | DEREGISTERED.NOR- | received with | | connection for |
| | | MAL-SERVICE | the 5GMM | | the cases c) and |
| | | 5GMM- | cause #9 or #10 | | d) as described |
| | | REGISTERED.NON- | SERVICE | | in |
| | | ALLOWED-SERVICE | REJECT | | subclause 5.3.1.3 |
| | | | message | | and |
| | | | received with | | initiation of the |
| | | | the 5GMM | | registration |
| | | | cause #9, #10 or | | procedure as |
| | | | #28 | | specified in |
| | | | | | subclause 5.5.1.2.2 |
| | | | | | or |
| | | | | | 5.5.1.3.2 |
| Non- | Default 54 | All 5GMM state over non- | Entering | N1 NAS signalling | Implicitly de- |
| 3GPP | min. | 3GPP access except | 5GMM-IDLE | connection over | overregister the UE |
| de- | NOTE 1 | 5GMM- | mode overnon- | non-3GPP access | for non-3GPP |
| registration | NOTE 2 | DEREGISTERED | 3GPP access | established or when | access on 1^{st} |
| timer | NOTE 4 | non-3GPP access | | entering state | expiry |
| | | | | 5GMM- | |
| | | | | DEREGISTERED | |
| | | | | over non-3GPP | |
| | | | | access | |
| T3526 | NOTE 9 | 5GMM- | Rejected S- | Associated S- | Remove the S- |
| | | DEREGISTERED | NSSAI with | NSSAI in the | NSSAI in the |
| | | 5GMM-REGISTERED | rejection cause | rejected NSSAI for | rejected |
| | | | “S-NSSAI not | the maximum | NSSAI for the |
| | | | available due to | number of UE | maximum |
| | | | maximum | reached as specified | number of UEs |
| | | | number of UE | in subclause 4.6.2.2 | reached |
| | | | reached” | deleted. | associated with |
| | | | received. | | the T3526 |
| | | | | | timer. |
| T3527 | 15 s | 5GMM- | Transmission of | RELAY KEY | Retransmission |
| | | REGISTERED.NORMAL- | RELAY KEY | REJECT message | of RELAY |
| | | SERVICE | REQUEST | received or | KEY |
| | | | message | RELAY | REQUEST |
| | | | Transmission of | AUTHENTICATION | message |
| | | | RELAY | REQUEST | |
| | | | AUTHENTICATION | message received or | |
| | | | RESPONSE | RELAY KEY | |
| | | | message | ACCEPT message | |
| | | | | received | |

NOTE 1:
The value of this timer is provided by the network operator during the registration procedure.
NOTE 2:
The default value of this timer is used if the network does not indicate a value in the REGISTRATION ACCEPT message and the UE does not have a stored value for this timer.
NOTE 3:
The value of this timer is UE implementation specific, with a minimum value of 60 seconds if not in NB-N1 mode and if not in WB-N1/CE mode.
NOTE 4:
If the T3346 value received in the mobility management messages is greater than the value of the non-3GPP de-registration timer, the UE sets the non-3GPP de-registration timer value to be 4 minutes greater than the value of timer T3346.
NOTE 5:
The conditions for which this applies are described in subclause 5.5.1.3.7.
NOTE 6:
The conditions for which this applies to the 5GMM-SERVICE-REQUEST-INITIATED state are described in subclause 5.4.1.3.7 case c) and case d).
NOTE 7:
In NB-N1 mode, the timer value shall be calculated as described in subclause 4.17.
NOTE 8:
In WB-N1 mode, if the UE supports CE mode B and operates in either CE mode A or CE mode B, then the timer value is as described in this table for the case of WB-N1/CE mode (see subclause 4.19).
NOTE 9:
The value of this timer is provided by the network operator during the registration procedure or the generic UE configuration update procedure along with the rejected S-NSSAI with rejection cause “S-NSSAI not available due to maximum number of UEs reached”. The default value of this timer is implementation specific with a minimum value of 12 minutes and used if the network does not provide a value in the REGISTRATION ACCEPT message, the REGISTRATION REJECT message, or the CONFIGURATION UPDATE COMMAND message along with the rejected S-NSSAI with rejection cause “S-NSSAI not available due to maximum number of UEs reached”.
NOTE 10:
Based on implementation, the timer may be set to a value between 250 ms and 15 s when the MUSIM UE indicates “NAS signalling connection release″ in the UE request type IE of
the SERVICE REQUEST message or CONTROL PLANE SERVICE REQUEST message.
NOTE 11:
Based on implementation, the timer may be set to a value between 250ms and 10s when the MUSIM UE not in NB-N1 mode or WB-NI mode indicated ″NAS signalling connection release” or “Rejection of paging” in the UE request type IE of the SERVICE REQUEST message or CONTROL PLANE SERVICE REQUEST message; or indicated “NAS signalling connection release” in the UE request type IE of the REGISTRATION REQUEST message.
NOTE 12:
In satellite NG-RAN access, this value shall be selected when satellite NG-RAN RAT type is NR(MEO) or NR(GEO).

TABLE 2
Table 2 depicts 5GC Mobility Management Timers at the AMF side.

| TIMER | TIMER | | CAUSE OF | | ON |
|---|---|---|---|---|---|
| NUM. | VALUE | STATE | START | NORMAL STOP | EXPIRY |
| T3513 | NOTE 4 | 5GMM- | Paging procedure | Paging procedure | Network |
| NOTE 7 | | REGISTERED | initiated | completed as | dependent |
| NOTE 9 | | | | specified in | |
| | | | | subclause 5.6.2.2.1 | |
| T3522 | 6 s | 5GMM- | Transmission of | DEREGISTRATION | Retransmission of |
| NOTE 6 | In WB- | DEREGISTERED- | DEREGISTRATION | ACCEPT | DEREGISTRATION |
| NOTE 8 | N1/CE | INITIATED | REQUEST | message received | REQUEST |
| | mode, | | message | | message |
| | 24 s | | | | |
| | For | | | | |
| | access | | | | |
| | via a | | | | |
| | satellite | | | | |
| | NG- | | | | |
| | RAN | | | | |
| | cell, 11 s | | | | |
| | NOTE 12 | | | | |
| T3550 | 6 s | 5GMM- | Transmission of | REGISTRATION | Retransmission of |
| NOTE 6 | In WB- | COMMON- | REGISTRATION | COMPLETE | REGISTRATION |
| NOTE 8 | N1/CE | PROCEDURE- | ACCEPT message | message received | ACCEPT message |
| | mode, | INITIATED | as specified in | | |
| | 18 s | | subclause 5.5.1.2.4 | | |
| | For | | and 5.5.1.3.4 | | |
| | access | | | | |
| | via a | | | | |
| | satellite | | | | |
| | NG- | | | | |
| | RAN | | | | |
| | cell, 11 s | | | | |
| | NOTE 12 | | | | |
| T3555 | 6 s | 5GMM- | Transmission of | CONFIGURATION | Retransmission of |
| NOTE 6 | In WB- | REGISTERED | CONFIGURATION | UPDATE | CONFIGURATION |
| NOTE 8 | N1/CE | | UPDATE | COMPLETE | UPDATE |
| | mode, | | COMMAND | message received | COMMAND |
| | 24 s | | message with | | message |
| | For | | “acknowledgement | | |
| | access | | requested” set in | | |
| | via a | | the | | |
| | satellite | | Acknowledgement | | |
| | NG- | | bit of the | | |
| | RAN | | Configuration | | |
| | cell, 11 s | | update indication | | |
| | NOTE 12 | | IE | | |
| T3560 | 6 s | 5GMM- | Transmission of | AUTHENTICATION | Retransmission of |
| NOTE 6 | In WB- | COMMON- | AUTHENTICATION | RESPONSE | AUTHENTICATION |
| NOTE 8 | N1/CE | PROCEDURE- | REQUEST | message received | REQUEST |
| | mode, | INITIATED | message | AUTHENTICATION | message or |
| | 24 s | | Transmission of | FAILURE | SECURITY |
| | For | | SECURITY | message received | MODE |
| | access | | MODE | SECURITY | COMMAND |
| | via a | | COMMAND | MODE | message |
| | satellite | | message | COMPLETE | |
| | NG- | | | message received | |
| | RAN | | | SECURITY | |
| | cell, 11 s | | | MODE REJECT | |
| | | | | message received | |
| T3565 | 6 s | 5GMM- | Transmission of | SERVICE | Retransmission of |
| NOTE 6 | In WB | REGISTERED | NOTIFICATION | REQUEST | NOTIFICATION |
| NOTE 8 | N1/CE | | message | message received | message |
| | mode, | | | CONTROL | |
| | 24 s For | | | PLANE SERVICE | |
| | access | | | REQUEST | |
| | via a | | | message received | |
| | satellite | | | NOTIFICATION | |
| | NG- | | | RESPONSE | |
| | RAN | | | message received | |
| | cell, 11 s | | | REGISTRATION | |
| | NOTE 12 | | | REQUEST | |
| | | | | Message received | |
| | | | | DEREGISTRATION | |
| | | | | REQUEST | |
| | | | | message received | |
| | | | | NGAP UE context | |
| | | | | resume request | |
| | | | | message as | |
| | | | | specified in | |
| | | | | 3GPP TS 38.413 [31] | |
| | | | | received | |
| T3570 | 6 s | 5GMM- | Transmission of | IDENTITY | Retransmission of |
| NOTE 6 | In WB- | COMMON- | IDENTITY | RESPONSE | IDENTITY |
| NOTE 8 | N1/CE | PROCEDURE- | REQUEST | message received | REQUEST |
| | mode, | INITIATED | message | | message |
| | 24 s | | | | |
| | For | | | | |
| | access | | | | |
| | via a | | | | |
| | satellite | | | | |
| | NG- | | | | |
| | RAN | | | | |
| | cell, 11 s | | | | |
| | NOTE 12 | | | | |
| T3575 | 15 s | 5GMM- | Transmission of | NETWORK | Retransmission of |
| NOTE6 | In WB- | REGISTERED | NETWORK | SLICE-SPECIFIC | NETWORK |
| NOTE 8 | N1/CE | | SLICE-SPECIFIC | AUTHENTICATION | SLICE-SPECIFIC |
| | mode, | | AUTHENTICATION | COMPLETE | AUTHENTICATION |
| | 60 s | | COMMAND | message received | ON COMMAND |
| | For | | message | | message |
| | access | | | | |
| | via a | | | | |
| | satellite | | | | |
| | NG- | | | | |
| | RAN | | | | |
| | cell, 27 s | | | | |
| | NOTE 12 | | | | |
| Active timer | NOTE 10 | All except | Entering 5GMM- | N1 NAS | Activate MICO |
| | | 5GMM- | IDLE mode after | signalling connection | mode for the UE. |
| | | DEREGISTERED | indicating MICO | established | |
| | | | mode activation to | | |
| | | | the UE with an | | |
| | | | active timer value. | | |
| Implicit de- | NOTE 2 | All except | The mobile | N1 NAS signalling | Implicitly de- |
| registration | | 5GMM- | reachable timer | connection | register the UE on |
| timer | | DEREGISTERED | expires while the | established | 1st expiry |
| | | | network is in | | |
| | | | 5GNN-IDLE | | |
| | | | mode | | |
| | | | Entering 5GMM- | | |
| | | | IDLE mode over | | |
| | | | 3GPP access if the | | |
| | | | MICO mode is | | |
| | | | activated and | | |
| | | | strictly periodic | | |
| | | | monitoring timer is | | |
| | | | not running | | |
| | | | The strictly | | |
| | | | periodic | | |
| | | | monitoring timer | | |
| | | | expires while the | | |
| | | | network is in | | |
| | | | 5GMM-IDLE | | |
| | | | mode | | |
| Mobile | NOTE 1 | All except | Entering 5GMM- | N1 NAS signalling | Network |
| reachable | | 5GMM- | IDLE mode | connection | dependent, but |
| timer | | DEREGISTERED | | established | typically paging is |
| | | | | | halted on 1st |
| | | | | | expiry, and start |
| | | | | | implicit de- |
| | | | | | registration timer, |
| | | | | | if the UE is not |
| | | | | | registered for |
| | | | | | emergency |
| | | | | | services. |
| | | | | | Implicitly de- |
| | | | | | register the UE |
| | | | | | which is registered |
| | | | | | for emergency |
| | | | | | services |
| Non-3GPP | NOTE 3 | All except | Entering 5GMM- | N1 NAS signalling | Implicitly de- |
| implicit de- | | 5GMM- | IDLE mode over | connection over | register the UE for |
| registration | | DEREGISTERED | non-3GPP access | non-3GPP access | non-3GPP access |
| timer | | | | established | on 1^{S} expiry |
| Strictly | NOTE 5 | All except | At the successful | Entering 5GMM- | In 5GMM-IDLE |
| periodic | | 5GMM- | completion of | DEREGISTERED. | mode, start |
| monitoring | | DEREGISTERED | registration update | | implicit de- |
| timer | | | procedure if strictly | | registration timer |
| | | | periodic | | as specified in |
| | | | registration timer | | subclause 5.3.7. |
| | | | indication is | | In 5GMM- |
| | | | supported as | | CONNECTED |
| | | | specified in | | mode, Strictly |
| | | | subclause 5.3.7. | | periodic |
| | | | | | monitoring timer is |
| | | | | | started again as |
| | | | | | specified in |
| | | | | | subclause 5.3.7. |
| Implementation | NOTE 1 | 5GMM- | At the successful | DEREGISTRATION | Network-initiated |
| specific | | REGISTERED | completion of | REQUEST | de-registration |
| timer for | | | initial registration | message received. | procedure |
| onboarding | | | for onboarding | | performed |
| services | | | services in SNPN | | |
| | | | or initial | | |
| | | | registration for the | | |
| | | | UE which the | | |
| | | | subscription is only | | |
| | | | for configuration of | | |
| | | | SNPN subscription | | |
| | | | parameters in | | |
| | | | PLMN via the user | | |
| | | | plane or successful | | |
| | | | completion of | | |
| | | | registration | | |
| | | | procedure for | | |
| | | | mobility and | | |
| | | | periodic | | |
| | | | registration update | | |
| | | | if the | | |
| | | | implementation | | |
| | | | specific timer for | | |
| | | | onboarding | | |
| | | | services is not | | |
| | | | running and: | | |
| | | | the UE is registered | | |
| | | | for onboarding | | |
| | | | services in SNPN; or | | |
| | | | the UE's | | |
| | | | subscription only | | |
| | | | allows for | | |
| | | | configuration of | | |
| | | | SNPN subscription | | |
| | | | parameters in | | |
| | | | PLMN via the user | | |
| | | | plane. | | |

NOTE 1:
The default value of this timer is 4 minutes greater than the value of timer T3512. If the UE is registered for emergency services, the value of this timer is set equal to the value of timer T3512. If the T3346 value provided in the mobility management messages is greater than the value of the timer T3512, the AMF sets the mobile reachable timer and the implicit de-registration timer such that the sum of the timer values is greater than the value of timer T3346.
NOTE 2:
The value of this timer is network dependent. If MICO is activated, the default value of this timer is 4 minutes greater than the value of timer T3512.
NOTE 3:
The value of this timer is network dependent. The default value of this timer is 4 minutes greater than the non-3GPP de-registration timer. If the T3346 value provided in the mobility management messages is greater than the value of the non-3GPP de-registration timer, the AMF sets the non-3GPP implicit de-registration timer value to be 8 minutes greater than the value of timer T3346.
NOTE 4:
The value of this timer is network dependent.
NOTE 5:
The value of this timer is the same as the value of timer T3512.
NOTE 6:
In NB-N1 mode, the timer value shall be calculated as described in subclause 4.17.
NOTE 7:
In NB-N1 mode, the timer value shall be calculated by using an NAS timer value which is network dependent.
NOTE 8:
In WB-N1 mode, if the UE supports CE mode B and operates in either CE mode A or CE mode B, then the timer value is as described in this table for the case of WB-N1/CE mode (see subclause 4.19).
NOTE 9:
In WB-N1 mode, if the UE supports CE mode B, then the timer value shall be calculated by using an NAS timer value which value is network dependent.
NOTE 10:
If the AMF includes timer T3324 in the REGISTRATION ACCEPT message and if the UE is not registered for emergency services, the value of this timer is equal to the value of timer T3324.
NOTE 11:
The value of this timer needs to be large enough to allow a UE to complete the configuration of one or more entries of the “list of subscriber data” and considering that configuration of SNPN subscription parameters in PLMN via the user plane or onboarding services in SNPN involves third party entities outside of the operator's network.
NOTE 12
In satellite NG-RAN access, this value shall be selected when satellite NG-RAN RAT type is NR(MEO) or NR(GEO).

TABLE 3
Table 3 depicts 5GC session management timers at the UE side.

| | | | | | ON THE |
|---|---|---|---|---|---|
| TIMER | TIMER | | | | 1^{st}, 2^{nd}, 3^{rd,} 4^{th} |
| NUM. | VALUE | STATE | CAUSE OF START | NORMAL STOP | EXPIRY (NOTE 1) |
| T3580 | 16 s | PDU SESSION | Transmission of PDU | PDU SESSION | Retransmission of |
| NOTE 4 | In WB- | ACTIVE | SESSION | ESTABLISHMENT | PDU SESSION |
| NOTE 5 | N1/CE | PENDING | ESTABLISHMENT | ACCEPT messages | ESTABLISHMENT |
| | mode, | | REQUEST message | received or | REQUEST |
| | 24 s | | | PDU SESSION | message |
| | For | | | ESTABLISHMENT | |
| | access | | | REJECT message | |
| | via a | | | received or | |
| | satellite | | | PDU SESSION | |
| | NG- | | | ESTABLISHMENT | |
| | RAN | | | REQUEST message | |
| | cell, 21 s | | | received in a DL NAS | |
| | NOTE 7 | | | TRANSPORT | |
| | | | | message with 5GMM | |
| | | | | cause #22, #28, #65. | |
| | | | | #67, #69, #90, #91 or | |
| | | | | #92 | |
| T3581 | 16 s | PDU SESSION | Transmission of PDU | PDU SESSION | Retransmission of |
| NOTE 4 | In WB- | MODIFICATION | SESSION | MODIFICATION | PDU SESSION |
| NOTE 5 | N1/CE | PENDING | MODIFICATION | COMMAND | MODIFICATION |
| | mode, | | REQUEST message | message with the | REQUEST |
| | 24 s | | | same PTI is received | messsage |
| | For | | | or PDU SESSION | |
| | access | | | MODIFICATION | |
| | via a | | | REJECT message | |
| | satellite | | | received or | |
| | NG- | | | PDU SESSION | |
| | RAN | | | MODIFICATION | |
| | cell, 21 s | | | REQUEST message | |
| | NOTE 7 | | | received in a DL NAS | |
| | | | | TRANSPORT | |
| | | | | message with 5GMM | |
| | | | | cause #22, #28. #67, | |
| | | | | #69, or #90 | |
| T3582 | 16 s | PDU SESSION | Transmission of PDU | PDU SESSION | Retransmission of |
| NOTE 4 | In WB- | INACTIVE | SESSION RELEASE | RELEASE | PDU SESSION |
| NOTE 5 | N1/CE | PENDING | REQUEST message | COMMAND | RELEASE |
| | mode, | | | message with the | REQUEST |
| | 24 s | | | same PTI is received | message |
| | For | | | or PDU SESSION | |
| | access | | | RELEASE REJECT | |
| | via a | | | message received | |
| | satellite | | | | |
| | NG- | | | | |
| | RAN | | | | |
| | cell, 21 s | | | | |
| | NOTE 7 | | | | |
| T3583 | Default | PDU SESSION | UE creates or updates | UE deletes the | On 1^{st} expiry: |
| | 1 min. | ACTIVE | a derived QoS rule | derived QoS rule (see | Deletion of the |
| | NOTE 2 | | | subclause 6.2.5.1.4.5) | derived QoS rule |
| T3584 | NOTE 3 | PDU SESSION | PDU SESSION | PDU SESSION | None |
| | | ACTIVE | ESTABLISHMENT | RELEASE | |
| | | PENDING | REJECT, PDU | COMMAND | |
| | | PDU SESSION | SESSION | message (see | |
| | | MODIFICATION | MODIFICATION | NOTE 6) or PDU | |
| | | PENDING | REJECT, or PDU | SESSION | |
| | | PDU SESSION | SESSION RELEASE | MODIFICATION | |
| | | ACTIVE or PDU | COMMAND | COMMAND | |
| | | SESSION | received with 5GSM | message or PDU | |
| | | INACTIVE | cause #67 and with a | SESSION | |
| | | PENDING | timer value for T3584 | AUTHENTICATION | |
| | | | PDU SESSION | COMMAND | |
| | | | ESTABLISHMENT | message or | |
| | | | REQUEST, or PDU | DEREGISTRATION | |
| | | | SESSION | REQUEST message | |
| | | | MODIFICATION | with the re- | |
| | | | REQUEST received | registration type “re- | |
| | | | in a DL NAS | registration required″ | |
| | | | TRANSPORT | | |
| | | | message with 5GMM | | |
| | | | cause #67 and with a | | |
| | | | timer value for T3584 | | |
| | | | (see | | |
| | | | subclause 5.4.5.3.3) | | |
| T3585 | NOTE 3 | PDU SESSION | PDU SESSION | DU SESSION | None |
| | | ACTIVE | ESTABLISHMENT | RELEASE | |
| | | PENDING | REJECT, PDU | PDUCOMMAND | |
| | | PDU SESSION | SESSION | message (see | |
| | | MODIFICATION | MODIFICATION | NOTE 6) or PDU | |
| | | PENDING | REJECT, or PDU | SESSION | |
| | | PDU SESSION | SESSION RELEASE | MODIFICATION | |
| | | ACTIVE or PDU | COMMAND | COMMAND | |
| | | SESSION | received with 5GSM | message or PDU | |
| | | INACTIVE | cause #69 and with a | SESSION | |
| | | PENDING | timer value for T3585 | AUTHENTICATION | |
| | | | PDU SESSION | COMMAND | |
| | | | ESTABLISHMENT | message or | |
| | | | REQUEST, or PDU | DEREGISTRATION | |
| | | | SESSION | REQUEST message | |
| | | | MODIFICATION | with the re- | |
| | | | REQUEST received | registration type “re- | |
| | | | in a DL NAS | registration required” | |
| | | | TRANSPORT | | |
| | | | message with 5GMM | | |
| | | | cause #69 and with a | | |
| | | | timer value for | | |
| | | | T3585(see | | |
| | | | subclause 5.4.5.3.3) | | |
| Back- | | | defined in | | |
| off | | | 3GPP TS 24.008 [12] | | |
| timer | | | | | |
| T3586 | 8 s | PDU SESSION | REMOTE UE | REMOTE UE | On the 1^{st} and 2^{nd} |
| NOTE 4 | In WB- | ACTIVE | REPORT message | REPORT | expiry, |
| NOTE 5 | N1/CE | | sent | RESPONSE message | retransmission of |
| | mode, | | | received | REMOTE UE |
| | 16 s | | | | REPORT message |
| | For | | | | On the 3^{rd} expiry, |
| | access | | | | the procedure is |
| | via a | | | | aborted (see |
| | satellite | | | | subclause 6.6.2.4). |
| | NG- | | | | |
| | RAN | | | | |
| | cell, 13 s | | | | |
| | NOTE 7 | | | | |
| T3587 | NOTE 8 | PDU SESSION | PDI SESSION | None | Initiating a request |
| | | ACTIVE | MODIFICATION | | to join the multicast |
| | | | COMMAND | | MBS session |
| | | | message or PDU | | associated with the |
| | | | SESSION | | PDU session if still |
| | | | ESTABLISHMENT | | needed |
| | | | ACCEPT message | | |
| | | | received with | | |
| | | | Received MBS | | |
| | | | information that | | |
| | | | includes MBS | | |
| | | | decision set to “MBS | | |
| | | | join is rejected” and | | |
| | | | Rejection cause set to | | |
| | | | “multicast MBS | | |
| | | | session has not | | |
| | | | started or will not | | |
| | | | start soon” and an | | |
| | | | MBS back-off timer | | |
| | | | value | | |

NOTE 1:
Typically, the procedures are aborted on the fifth expiry of the relevant timer. Exceptions are described in the corresponding procedure description.
NOTE 2:
The network may provide the value of this timer applicable to the derived QoS rules of a specific PDU session as RQ timer value in the PDU SESSION ESTABLISHMENT ACCEPT message and PDU SESSION MODIFICATION COMMAND message. The maximum value of the timer is 30 min. If the network indicates a value greater than the maximum value, then the UE shall use the maximum value.
NOTE 3:
The value of this timer is provided by the network.
NOTE 4:
In NB-N1 mode, then the timer value shall be calculated as described in subclause 4.18.
NOTE 5:
In WB-N1 mode, if the UE supports CE mode B and operates in either CE mode A or CE mode B, then the timer value is as described in this table for the case of WB-N1/CE mode (see subclause 4.20).
NOTE 6:
If the PDU SESSION RELEASE COMMAND message includes the Back-off timer value IE where the timer value indicates neither zero nor deactivated and the 5GSM cause is not #39, the UE then starts the timer with the value provided in the Back-off timer value IE after stopping the existing timer (see subclause 6.3.3.3).
NOTE 7:
In satellite NG-RAN access, this value shall be selected when satellite NG-RAN RAT type is NR(MEO) or NR(GEO).
NOTE 8:
The value of this timer is provided by the network in the Received MBS container IE (see subclause 6.3.2.3, subclause 6.4.1.3 and subclause 9.11.4.31).

TABLE 4
Table 4 depicts 5GS session management timer at the SMF side.

| | | | | | |
|---|---|---|---|---|---|
| T3584 | NOTE 3 | PDU SESSION | PDU SESSION | PDU SESSION | None |
| | | ACTIVE | ESTABLISHMENT | RELEASE | |
| | | PENDING | REJECT, PDU | COMMAND | |
| | | PDU SESSION | SESSION | message (see | |
| | | MODIFICATION | MODIFICATION | NOTE 6) or PDU | |
| | | PENDING | REJECT, or PDU | SESSION | |
| | | PDU SESSION | SESSION RELEASE | MODIFICATION | |
| | | ACTIVE or PDU | COMMAND received | COMMAND | |
| | | SESSION | with 5GSM cause #67 | message or PDU | |
| | | INACTIVE | and with a timer value | SESSION | |
| | | PENDING | for T3584 | AUTHENTICATION | |
| | | | PDU SESSION | COMMAND | |
| | | | ESTABLISHMENT | message or | |
| | | | REQUEST, or PDU | DEREGISTRATION | |
| | | | SESSION | REQUEST message | |
| | | | MODIFICATION | with the re- | |
| | | | REQUEST received in | registration type “re- | |
| | | | a DL NAS | registration required” | |
| | | | TRANSPORT | | |
| | | | message with 5GMM | | |
| | | | cause #67 and with a | | |
| | | | timer value for T3584 | | |
| | | | (see | | |
| | | | subclause 5.4.5.3.3) | | |
| T3585 | NOTE 3 | PDU SESSION | PDU SESSION | DU SESSION | None |
| | | ACTIVE | ESTABLISHMENT | RELEASE | |
| | | PENDING | REJECT, PDU | COMMAND | |
| | | PDU SESSION | SESSION | message (see | |
| | | MODIFICATION | MODIFICATION | NOTE 6) or PDU | |
| | | PENDING | REJECT, or PDU | SESSION | |
| | | PDU SESSION | SESSION RELEASE | MODIFICATION | |
| | | ACTIVE or PDU | COMMAND received | COMMAND | |
| | | SESSION | with 5GSM cause #69 | message or PDU | |
| | | INACTIVE | and with a timer value | SESSION | |
| | | PENDING | for T3585 | AUTHENTICATION | |
| | | | PDU SESSION | COMMAND | |
| | | | ESTABLISHMENT | message or | |
| | | | REQUEST, or PDU | DEREGISTRATION | |
| | | | SESSION | REQUEST message | |
| | | | MODIFICATION | with the re- | |
| | | | REQUEST received in | registration type “re- | |
| | | | a DL NAS | registration required” | |
| | | | TRANSPORT | | |
| | | | message with 5GMM | | |
| | | | cause #69 and with a | | |
| | | | timer value for | | |
| | | | T3585(see | | |
| | | | subclause 5.4.5.3.3) | | |
| Back- | | | defined in | | |
| off | | | 3GPP TS 24.008 [12] | | |
| timer | | | | | |
| T3586 | 8 s | PDU SESSION | REMOTE UE | REMOTE UE | On the 1^{st} and 2^{nd} |
| NOTE | In WB- | ACTIVE | REPORT message sent | REPORT | expiry, |
| 4 | N1/CE | | | RESPONSE message | retransmission of |
| NOTE | mode, | | | received | REMOTE UE |
| 5 | 16 s | | | | REPORT |
| | For | | | | message |
| | access | | | | On the 3^{rd} expiry, |
| | via a | | | | the procedure is |
| | satellite | | | | aborted (see |
| | NG- | | | | subclause 6.6.2.4) |
| | RAN | | | | |
| | cell, 13 s | | | | |
| | NOTE 7 | | | | |
| T3587 | NOTE 8 | PDU SESSION | PDU SESSION | None | Initiating a |
| | | ACTIVE | MODIFICATION | | request to join the |
| | | | COMMAND message | | multicast MBS |
| | | | or PDU SESSION | | session associated |
| | | | ESTABLISHMENT | | with the PDU |
| | | | ACCEPT message | | session if still |
| | | | received with Received | | needed |
| | | | MBS information that | | |
| | | | includes MBS decision | | |
| | | | set to “MBS join is | | |
| | | | rejected” and Rejection | | |
| | | | cause set to “multicast | | |
| | | | MBS session has not | | |
| | | | started or will not start | | |
| | | | soon” and an MBS | | |
| | | | back-off timer value | | |

NOTE 1:
Typically, the procedures are aborted on the fifth expiry of the relevant timer. Exceptions are described in the corresponding procedure description.
NOTE 2:
The network may provide the value of this timer applicable to the derived QoS rules of a specific PDU session as RQ timer value in the PDU SESSION ESTABLISHMENT ACCEPT message and PDU SESSION MODIFICATION COMMAND message. The maximum value of the timer is 30 min. If the network indicates a value greater than the maximum value, then the UE shall use the maximum value.
NOTE 3:
The value of this timer is provided by the network.
NOTE 4:
In NB-N1 mode, then the timer value shall be calculated as described in subclause 4.18.
NOTE 5:
In WB-N1 mode, if the UE supports CE mode B and operates in either CE mode A or CE mode B, then the timer value is as described in this table for the case of WB-N1/CE mode (see subclause 4.20).
NOTE 6:
If the PDU SESSION RELEASE COMMAND message includes the Back-off timer value IE where the timer value indicates neither zero nor deactivated and the 5GSM cause is not #39, the UE then starts the timer with the value provided in the Back-off timer value IE after stopping the existing timer (see subclause 6.3.3.3).
NOTE 7:
In satellite NG-RAN access, this value shall be selected when satellite NG-RAN RAT type is NR(MEO) or NR(GEO).
NOTE 8:
The value of this timer is provided by the network in the Received MBS container IE (see subclause 6.3.2.3, subclause 6.4.1.3 and subclause 9.11.4.31).

TABLE 5
Table 5 depicts EPS mobility management timers at the UE side.

| TIMER | TIMER | | | | ON |
|---|---|---|---|---|---|
| NUM. | VALUE | STATE | CAUSE OF START | NORMAL STOP | EXPIRY |
| T3402 | Default 12 | EMM- | At attach failure and | ATTACH | Initiation of the |
| | min. | DEREGISTERED | the attempt counter | REQUEST sent | attach |
| | NOTE 1 | EMM-REGISTERED | is equal to 5. | TRACKING | procedure, if |
| | | | At tracking area | AREA UPDATE | still required or |
| | | | updating failure and | REQUEST sent | tracking area |
| | | | the attempt counter | NAS signalling | updating |
| | | | is equal to 5. | connection | procedure |
| | | | ATTACH ACCEPT | released | |
| | | | with EMM cause | | |
| | | | #16 or #17 and the | | |
| | | | attempt counter is | | |
| | | | equal to 5 for CS/PS | | |
| | | | mode 2 UE, or | | |
| | | | ATTACH ACCEPT | | |
| | | | with EMM cause | | |
| | | | #22, as described in | | |
| | | | clause 5.5.1.3.4.3. | | |
| | | | TRACKING AREA | | |
| | | | UPDATE ACCEPT | | |
| | | | with EMM cause | | |
| | | | #16 or #17 and the | | |
| | | | attempt counter is | | |
| | | | equal to 5 for CS/PS | | |
| | | | mode 2 UE. | | |
| | | | TRACKING AREA | | |
| | | | UPDATE ACCEPT | | |
| | | | with EMM cause | | |
| | | | #16 or #17 and the | | |
| | | | attempt counter is | | |
| | | | equal to 5 for CS/PS | | |
| | | | mode 1 UE with | | |
| | | | “IMS voice not | | |
| | | | available” and with a | | |
| | | | persistent EPS | | |
| | | | bearer context, or | | |
| | | | TRACKING AREA | | |
| | | | UPDATE ACCEPT | | |
| | | | with EMM cause | | |
| | | | #22, as described in | | |
| | | | clause 5.5.3.3.4.3. | | |
| | | | ATTACH ACCEPT | | |
| | | | and the attempt | | |
| | | | counter is equal to 5 | | |
| | | | as described in | | |
| | | | clause 5.5.1.2.4A | | |
| | | | and 5.5.1.2.6A. | | |
| | | | TRACKING AREA | | |
| | | | UPDATE ACCEPT | | |
| | | | and the attempt | | |
| | | | counter is equal to 5 | | |
| | | | as described in | | |
| | | | clause 5.5.3.2.4A | | |
| | | | and 5.5.3.2.6A. | | |
| | | | DETACH | | |
| | | | REQUEST with | | |
| | | | other EMM cause | | |
| | | | values than those | | |
| | | | treated in | | |
| | | | clause 5.5.2.3.2 or | | |
| | | | no EMM cause IE | | |
| | | | and Detach type IE | | |
| | | | indicates “re-attach | | |
| | | | not required” as | | |
| | | | described in clause | | |
| | | | 5.5.2.3.4. | | |
| T3410 | 15 s | EMM-REGISTERED- | ATTACH | ATTACH | Start T3411 or |
| | NOTE 7 | INITIATED | REQUEST sent | ACCEPT | T3402 as |
| | NOTE 8 | | | received | described in |
| | In WB- | | | ATTACH | clause 5.5.1.2.6 |
| | S1/CE | | | REJECT | |
| | mode, 85 s | | | received | |
| T3411 | 10 s | EMM- | At attach failure due | ATTACH | Retransmission |
| | | DEREGISTERED. | to lower layer | REQUEST sent | of the ATTACH |
| | | ATTEMPTING-TO- | failure, T3410 | TRACKING | REQUEST, if |
| | | ATTACH | timeout or attach | AREA UPDATE | still required as |
| | | EMM-REGISTERED. | rejected with other | REQUEST sent | described in |
| | | ATTEMPTING-TO- | EMM cause values | EMM- | clause 5.5.1.2.6 |
| | | UPDATE | than those treated in | CONNECTED | or |
| | | EMM-REGISTERED. | clause 5.5.1.2.5. | mode entered | retransmission |
| | | NORMAL-SERVICE | At tracking area | (NOTE 6) | of TRACKING |
| | | | updating failure due | | AREA |
| | | | to lower layer | | UPDATE |
| | | | failure, T3430 | | REQUEST |
| | | | timeout or TAU | | |
| | | | rejected with other | | |
| | | | EMM cause values | | |
| | | | than those treated in | | |
| | | | clause 5.5.3.2.5. | | |
| | | | ATTACH ACCEPT | | |
| | | | and the attempt | | |
| | | | counter is less than 5 | | |
| | | | as described in | | |
| | | | clause 5.5.1.2.4A | | |
| | | | and 5.5.1.2.6A. | | |
| | | | TRACKING AREA | | |
| | | | UPDATE ACCEPT | | |
| | | | and the attempt | | |
| | | | counter is less than 5 | | |
| | | | as described in | | |
| | | | clause 5.5.3.2.4A | | |
| | | | and 5.5.3.2.6A. | | |
| T3412 | Default 54 | EMM-REGISTERED | In EMM- | When entering | Initiation of the |
| | min. NOTE | | REGISTERED, | state EMM- | periodic |
| | 2 | | when EMM- | DEREGISTERED | tracking area |
| | NOTE 5 | | CONNECTED | or when | updating |
| | | | mode is left. | entering EMM- | procedure if the |
| | | | | CONNECTED | UE is not |
| | | | | mode. | attached for |
| | | | | | emergency |
| | | | | | bearer services |
| | | | | | or T3423 started |
| | | | | | under the |
| | | | | | conditions as |
| | | | | | specified in |
| | | | | | clause 5.3.5. |
| | | | | | Implicit detach |
| | | | | | from network if |
| | | | | | the UE is |
| | | | | | attached for |
| | | | | | emergency |
| | | | | | bearer services. |
| T3416 | 30s | EMM-REGISTERED- | RAND and RES | SECURITY | Delete the |
| | NOTE 7 | INITIATED | stored as a result of | MODE | stored RAND |
| | NOTE 8 In | EMM-REGISTERED | an EPS | COMMAND | and RES |
| | WB-S1/CE | EMM- | authentication | received | |
| | mode, 48 s | DEREGISTERED- | challenge | SERVICE | |
| | | INITIATED | | REJECT | |
| | | EMM-TRACKING- | | received | |
| | | AREA-UPDATING- | | SERVICE | |
| | | INITIATED | | ACCEPT | |
| | | EMM-SERVICE- | | received | |
| | | REQUEST- | | TRACKING | |
| | | INITIATED | | AREA UPDATE | |
| | | | | ACCEPT | |
| | | | | received | |
| | | | | AUTHENTICATION | |
| | | | | REJECT | |
| | | | | received | |
| | | | | AUTHENTICATION | |
| | | | | FAILURE | |
| | | | | sent | |
| | | | | EMM- | |
| | | | | DEREGISTERED, | |
| | | | | EMM-NULL | |
| | | | | or | |
| | | | | EMM-IDLE | |
| | | | | mode entered | |
| T3417 | 5 s | EMM-SERVICE- | SERVICE | Bearers have | Abort the |
| | NOTE 7 | REQUEST- | REQUEST sent or | been set up | procedure |
| | NOTE 8 | INITIATED | EXTENDED | SERVICE | |
| | NOTE 13 | | SERVICE | REJECT | |
| | In WB- | | REQUEST sent with | received | |
| | S1/CE | | service type set to | SERVICE | |
| | mode, 51 s | | “packet services via | ACCEPT | |
| | | | S1” in case a, b, c, h, | received | |
| | | | k, l and o in | Indication of | |
| | | | clause 5.6.1.1 | system change | |
| | | | EXTENDED | from lower layer | |
| | | | SERVICE | received | |
| | | | REQUEST sent in | cdma2000 ® | |
| | | | case f, g, i, j, p and q | 1xCS fallback | |
| | | | in clause 5.6.1.1 | rejection | |
| | | | CONTROL PLANE | received | |
| | | | SERVICE | see | |
| | | | REQUEST sent as | clause 5.6.1.4.2 | |
| | | | specified in | | |
| | | | clause 5.6.1.2.2 | | |
| T3417 | 10 s | EMM-SERVICE- | EXTENDED | Inter-system | Select GERAN |
| ext | | REQUEST- | SERVICE | change from S1 | or UTRAN |
| | | INITIATED | REQUEST sent in | mode to A/Gb | |
| | | | case d in | mode or Iu mode | |
| | | | clause 5.6.1.1 | is completed | |
| | | | | Inter-system | |
| | | | | change from S1 | |
| | | | | mode to A/Gb | |
| | | | | mode or Iu mode | |
| | | | | is failed | |
| | | | | SERVICE | |
| | | | | REJECT | |
| | | | | received | |
| T3417 | 4 s | EMM-SERVICE- | EXTENDED | Inter-system | Select GERAN |
| ext-mt | | REQUEST- | SERVICE | change from S1 | or UTRAN |
| | | INITIATED | REQUEST sent in | mode to A/Gb | |
| | | | case e in | mode or Iu mode is | |
| | | | clause 5.6.1.1 and | completedInter- | |
| | | | the CSFB response | system change | |
| | | | was set to “CS | from S1 mode to | |
| | | | fallback accepted | A/Gb mode or Iu | |
| | | | the UE” | mode is failed | |
| | | | | SERVICE | |
| | | | | REJECT | |
| | | | | received | |
| T3418 | 20 s | EMM-REGISTERED- | AUTHENTICATION | AUTHENTICATION | On first expiry, |
| | NOTE 7 | INITIATED | FAILURE (EMM | REQUEST | the UE should |
| | NOTE 8 In | EMM-REGISTERED | cause = #20 “MAC | received or | consider the |
| | WB-S1/CE | EMM-TRACKING- | failure” or #26 “non- | AUTHENTICATION | network as false |
| | mode, 38 s | AREA-UPDATING- | EPS authentication | REJECT | and follow item |
| | | INITIATED | unacceptable”) sent | received | f of |
| | | EMM- | | or | clause 5.4.2.7, if |
| | | DEREGISTERED- | | SECURITY | the UE is not |
| | | INITIATED | | MODE | attached for |
| | | EMM-SERVICE- | | COMMAND | emergency |
| | | REQUEST- | | received | bearer services |
| | | INITIATED | | when entering | for access to |
| | | | | EMM-IDLE | RLOS. |
| | | | | mode | On first expiry, |
| | | | | indication of | the UE will |
| | | | | transmission | follow |
| | | | | failure of | clause 5.4.2.7 |
| | | | | AUTHENTICATION | under “For |
| | | | | FAILURE | items c, d, and |
| | | | | message from | e:”, if the UE is |
| | | | | lower layers | attached for |
| | | | | | emergency |
| | | | | | for bearer services |
| | | | | | or if the UE is |
| | | | | | attached for |
| | | | | | access to RLOS. |
| T3420 | 15 s | EMM-REGISTERED- | AUTHENTICATION | AUTHENTICATION | On first expiry, |
| | NOTE 7 | INITIATED | FAILURE (cause = | REQUEST | the UE should |
| | NOTE 8 In | EMM-REGISTERED | #21 “synch | received or | consider the |
| | WB-S1/CE | EMM- | failure”) sent | AUTHENTICATION | network as false |
| | mode, 33 s | DEREGISTERED- | | REJECT | and follow item |
| | | INITIATED | | received | f of |
| | | EMM-TRACKING- | | or | clause 5.4.2.7, if |
| | | AREA-UPDATING- | | SECURITY | the UE is not |
| | | INITIATED | | MODE | attached for |
| | | EMM-SERVICE- | | COMMAND | emergency |
| | | REQUEST- | | received | bearer services |
| | | INITIATED | | when entering | or access to |
| | | | | EMM-IDLE | RLOS. |
| | | | | mode | On first expiry, |
| | | | | indication of | the UE will |
| | | | | transmission | follow |
| | | | | failure of | clause 5.4.2.7 |
| | | | | AUTHENTICATION | under “For |
| | | | | FAILURE | items c, d, and |
| | | | | message from | e:”, if the UE is |
| | | | | lower layers | attached for |
| | | | | | emergency |
| | | | | | bearer services |
| | | | | | or if the UE is |
| | | | | | attached for |
| | | | | | access to RLOS. |
| T3421 | 15 sNOTE 7 | EMM- | DETACH | DETACH | Retransmission |
| | NOTE 8 | DEREGISTERED- | REQUEST sent with | ACCEPT | of DETACH |
| | In WB- | INITIATED | the Detach type IE | received | REQUEST |
| | S1/CE | EMM- | not indicating | | |
| | mode, 45 s | REGISTERED. | “switch off” | | |
| | | IMSI-DETACH- | | | |
| | | INITIATED | | | |
| T3423 | NOTE 3 | EMM-REGISTERED | T3412 expires while | When entering | Set TIN to “P- |
| | | | ISR is activated and | state EMM- | TMSI” |
| | | | either T3346 is | DEREGISTERED | For A/Gb mode |
| | | | running or the UE is | or when | or Iu mode, see |
| | | | in one of the | entering EMM- | 3GPP TS 24.00 |
| | | | following states:- | CONNECTED | 8 [13] |
| | | | EMM- | mode. | |
| | | | REGISTERED. NO- | | |
| | | | CELL- | | |
| | | | AVAILABLE; | | |
| | | | EMM- | | |
| | | | REGISTERED. PL | | |
| | | | MN-SEARCH; | | |
| | | | -EMM- | | |
| | | | REGISTERED. | | |
| | | | UPDATE-NEEDED; | | |
| | | | or | | |
| | | | -EMM- | | |
| | | | REGISTERED. | | |
| | | | LIMITED-SERVICE. | | |
| T3430 | 15 s | EMM-TRACKING- | TRACKING AREA | TRACKING | Start T3411 or |
| | NOTE | AREA-UPDATING- | UPDATE | AREA UPDATE | T3402 as |
| | 7 | INITIATED | REQUEST sent | ACCEPT | described in |
| | NOTE 8 In | | | received | clause 5.5.3.2.6 |
| | WB-S1/CE | | | TRACKING | |
| | mode, 77 s | | | AREA UPDATE | |
| | | | | REJECT | |
| | | | | received | |
| T3440 | 10 sNOTE 7 | EMM- | ATTACH REJECT, | NAS signalling | Release the |
| | (applicable | DEREGISTERED | DETACH | connection | NAS signalling |
| | to case k) | EMM-REGISTERED | REQUEST, | released | connection for |
| | clause 5.3.1. | | TRACKING AREA | Bearers have | the cases a), b), |
| | 2.1) | | UPDATE REJECT | been set up or a | c) and l)as |
| | NOTE 8 | | with any of the | request for PDN | described in |
| | In WB | | EMM cause #3, #6, | connection for | clause 5.3.1.2 |
| | S1/CE | | #7, #8, #11, #12, | emergency | |
| | mode, 34 s | | #13, #14, #15, #22, | bearer services or | |
| | (applicable | | #25, #31, #35, #36, | a CS emergency | |
| | to case k) in | | #42 or #78 | call is started | |
| | clause 5.3.1. | | SERVICE REJECT | Upon receipt of | |
| | 2.1) | | received with any of | ESM DATA | |
| | NOTE 14 | | the EMM cause #3, | TRANSPORT | |
| | | | #6, #7, #8, #11, #12, | message as | |
| | | | #13, #15, #22, #25, | described in | |
| | | | #31, #35, #36, #39, | clause 5.3.1.2.1 | |
| | | | #42 or #78 | (NOTE 9) | |
| | | | TRACKING AREA | | |
| | | | UPDATE ACCEPT | | |
| | | | described in clause | | |
| | | | 5.3.1.2.1 case | | |
| | | | b)DETACH | | |
| | | | ACCEPT received | | |
| | | | after the UE sent | | |
| | | | DETACH | | |
| | | | REQUEST with | | |
| | | | detach type to “IMSI | | |
| | | | detach” | | |
| | | | Upon receipt of | | |
| | | | ESM DATA | | |
| | | | TRANSPORT | | |
| | | | message as | | |
| | | | described in | | |
| | | | clause 5.3.1.2.1 | | |
| | | | (NOTE 9) | | |
| | | | AUTHENTICATION | | |
| | | | REJECT received | | |
| | | | SERVICE ACCEPT | | |
| | | | received as | | |
| | | | described in clause | | |
| | | | 5.3.1.2.1 case j) | | |
| | | | DETACH ACCEPT | | |
| | | | received as | | |
| | | | described in clause | | |
| | | | 5.3.1.2.1 case 1) | | |
| | | EMM- | TRACKING AREA | NAS signalling | Release the |
| | | DEREGISTEREDEMM- | UPDATE REJECT, | connection | NAS signalling |
| | | DEREGISTERED. | SERVICE REJECT | released | connection for |
| | | NORMAL-SERVICE | with any of the | | the cases d) and |
| | | | EMM cause #9, #10 | | e) as described |
| | | | or #40 | | in clause 5.3.1.2 |
| | | | | | and initiation of |
| | | | | | the attach |
| | | | | | procedure as |
| | | | | | specified in |
| | | | | | clause 5.5.3.2.5, |
| | | | | | 5.5.3.3.5 |
| | | | | | or |
| | | | | | 5.6.1.5 |
| T3442 | NOTE 4 | EMM-REGISTERED | SERVICE REJECT | TRACKING | None |
| | | | received with EMM | AREA UPDATE | |
| | | | cause #39 “CS | REQUEST sent | |
| | | | service temporarily | | |
| | | | not available” with a | | |
| | | | non-zero T3442 | | |
| | | | value | | |
| T3444 | NOTE 11 | All except EMM- | UE configured for | Removal of eCall | Perform eCall |
| | | NULL and 5GMM- | eCall only mode | only restriction- | inactivity |
| | | NULL (defined in | enters EMM-IDLE | Intersystem | procedure in |
| | | 3GPP TS 24.501 [54]) | mode after an eCall | change from S1 | EPS as |
| | | | over IMS-UE | mode to A/Gb or | described in |
| | | | configured for eCalll | Iu mode | clause 5.5.4. |
| | | | only mode moves | | Perform eCall |
| | | | from | | inactivity |
| | | | GERAN/UTRAN to | | procedure in |
| | | | E-UTRAN with | | 5GS as |
| | | | timer T3242 (see | | described in |
| | | | 3GPP TS 24.008 | | 3GPP TS 24.501 |
| | | | [13]) running- | | [54]. |
| | | | UE configured for | | |
| | | | eCall only mode | | |
| | | | enters 5GMM-IDLE | | |
| | | | mode or enters | | |
| | | | 5GMM- | | |
| | | | CONNECTED | | |
| | | | mode with RRC | | |
| | | | inactive indication | | |
| | | | (defined in | | |
| | | | 3GPP TS 24.501 | | |
| | | | [54]) after an eCall | | |
| | | | over IMS | | |
| T3445 | NOTE 12 | All except EMM- | UE configured for | Removal of eCall | Perform eCall |
| | | NULL and 5GMM- | eCall only mode | only restriction- | inactivity |
| | | NULL (defined in | enters EMM-IDLE | Intersystem | procedure in |
| | | 3GPP TS 24.501 [54]) | mode after a call to a | change from S1 | EPS as |
| | | | non-emergency | mode to A/Gb or | described in |
| | | | MSISDN or URI for | Iu mode | lause 5.5.4. |
| | | | test or terminal | | Perform eCall |
| | | | reconfiguration | | inactivity |
| | | | service-UE | | procedure in |
| | | | configured for eCall | | 5GS as |
| | | | only mode moves | | described in |
| | | | from | | 3GPP TS 24.501 |
| | | | GERAN/UTRAN to | | [54]. |
| | | | E-UTRAN with | | |
| | | | timer T3243 (see | | |
| | | | 3GPP TS 24.008 | | |
| | | | [13]) running- | | |
| | | | UE configured for | | |
| | | | eCall only mode | | |
| | | | enters 5GMM-IDLE | | |
| | | | mode or enters | | |
| | | | 5GMM- | | |
| | | | CONNECTED | | |
| | | | mode with RRC | | |
| | | | inactive indication | | |
| | | | (defined in | | |
| | | | 3GPP TS 24.501 | | |
| | | | [54]) after a call to a | | |
| | | | non-emergency | | |
| | | | MSISDN or URI for | | |
| | | | test or terminal | | |
| | | | reconfiguration | | |
| | | | service | | |
| T3447 | NOTE 2 | except EMM- | NAS signalling | ATTACH | Allowed to |
| | | NULL | connection release | ACCEPT or | initiate transfer |
| | | | that was not | TRACKING | of uplink user |
| | | | established for | AREA UPDATE | data |
| | | | paging, attach | ACCEPT without | |
| | | | without PDN | the T3447 value | |
| | | | connection or | IE. | |
| | | | tracking area update | Inter-system | |
| | | | request without | change from S1 | |
| | | | “active” or | mode to A/Gb | |
| | | | “signalling active” | mode or Iu mode | |
| | | | flag set. | is completed | |
| | | | N1 NAS signalling | REGISTRATION | |
| | | | connection release | ACCEPT | |
| | | | that was not | without the | |
| | | | established due to | T3447 value IE | |
| | | | paging, or | (defined in | |
| | | | REGISTRATION | 3GPP TS 24.501 | |
| | | | REQUEST for initial | [54]). | |
| | | | registration with | CONFIGURATION | |
| | | | Follow-on request | UPDATE | |
| | | | indicator set to No | COMMAND | |
| | | | follow-on request | with the T3447 | |
| | | | pending”, or | value IE set to | |
| | | | REGISTRATION | zero or | |
| | | | REQUEST for | deactivated | |
| | | | mobility and | (defined in | |
| | | | periodic registration | 3GPP TS 24.501 | |
| | | | update with Follow- | [54]). | |
| | | | on request indicator | | |
| | | | set to “No follow-on | | |
| | | | request pending” and | | |
| | | | without Uplink data | | |
| | | | status IE included | | |
| | | | (defined in | | |
| | | | 3GPP TS 24.501 | | |
| | | | [54]). | | |
| T3448 | NOTE 10 | All except EMM- | ATTACH ACCEPT | SERVICE | Allowed to |
| | | NULL and 5GMM- | message or | ACCEPT | initiate transfer |
| | | NULL (defined | TRACKING AREA | message or | of user data via |
| | | 3GPP TS 24.501 [54]) | UPDATE ACCEPT | TRACKING | the control |
| | | | message or | AREA UPDATE | plane |
| | | | SERVICE ACCEPT | ACCEPT | |
| | | | message received | message received | |
| | | | with a non-zero | without T3448 | |
| | | | T3448 value. | value | |
| | | | SERVICE REJECT | SERVICE | |
| | | | message received | ACCEPT | |
| | | | with EMM cause | message or | |
| | | | #22 “Congestion” | REGISTRATION | |
| | | | and a non-zero | ACCEPT | |
| | | | T3448 value. | message received | |
| | | | REGISTRATION | without T3448 | |
| | | | ACCEPT message | value(defined in | |
| | | | or SERVICE | 3GPP TS 24.501 | |
| | | | ACCEPT message | [54]) | |
| | | | received with a non- | | |
| | | | zero T3448 value | | |
| | | | (defined in | | |
| | | | 3GPP TS 24.501 | | |
| | | | [54]) | | |
| | | | SERVICE REJECT | | |
| | | | message received | | |
| | | | with 5GMM cause | | |
| | | | #22 “Congestion” | | |
| | | | and a non-zero | | |
| | | | T3448 value(defined | | |
| | | | in | | |
| | | | 3GPP TS 24.501 | | |
| | | | [54]) | | |
| T3449 | 5 s | EMM-REGISTERED | Bearers have been | SERVICE | SERVICE |
| | NOTE 7 | | set up | ACCEPT | ACCEPT |
| | NOTE 8 | | SECURITY MODE | message received | message |
| | In WB- | | COMMAND | Security | considered as a |
| | S1/CE | | message received | protected ESM | protocol error |
| | mode, 51 s | | | message or a | and EMM |
| | | | | security protected | STATUS |
| | | | | EMM message | returned |
| | | | | not related to an | |
| | | | | EMM common | |
| | | | | procedure | |
| | | | | received | |

NOTE 1:
The cases in which the default value of this timer is used are described in clause 5.3.6.
NOTE 2:
The value of this timer is provided by the network operator during the attach and tracking area updating procedures.
NOTE 3:
The value of this timer may be provided by the network in the ATTACH ACCEPT message and TRACKING AREA UPDATE ACCEPT message. The default value of this timer is identical to the value of T3412.
NOTE 4:
The value of this timer is provided by the network operator when a service request for CS fallback is rejected by the network with EMM cause #39 “CS service temporarily not available”.
NOTE 5:
The default value of this timer is used if the network does not indicate a value in the TRACKING AREA UPDATE ACCEPT message and the UE does not have a stored value for this timer.
NOTE 6:
The conditions for which this applies are described in clause 5.5.3.2.6.
NOTE 7:
In NB-S1 mode, the timer value shall be calculated as described in clause 4.7.
NOTE 8:
In WB-S1 mode, if the UE supports CE mode B and operates in either CE mode A or CE mode B, then the timer value is as described in this table for the case of WB-S1/CE mode (see clause 4.8).
NOTE 9:
It is possible that the UE does not stop or start timer T3440 upon receipt of ESM DATA TRANSPORT message as described in clause 5.3.1.2.1.
NOTE 10:
The timer value is provided by the network in the ATTACH ACCEPT, TRACKING AREA UPDATE ACCEPT, SERVICE ACCEPT, SERVICE REJECT or REGISTRATION ACCEPT message, or chosen randomly from a default value range of 15-30 minutes.
NOTE 11:
If the timer is started due to a UE configured for eCall only mode moving from GERAN/UTRAN to E-UTRAN with timer T3242 (see 3GPP TS 24.008 [13]) running, the UE starts the timer with a value set to the time left on timer T3242. Otherwise, the UE starts the timer with a value set to 12 hours.
NOTE 12:
If the timer is started due to a UE configured for eCall only mode moving from GERAN/UTRAN to E-UTRAN with timer T3243 (see 3GPP TS 24.008 [13]) running, the UE starts the timer with a value set to the time left on timer T3243. Otherwise, the UE starts the timer with a value set to 12 hours.
NOTE 13:
Based on implementation, the timer may be set to a value between 250 ms and 5 s when the MUSIM UE indicates “NAS signalling connection release” or “Rejection of paging” in the UE request type IE of the EXTENDED SERVICE REQUEST message or CONTROL PLANE SERVICE REQUEST message.
NOTE 14:
Based on implementation, the timer may be set to a value between 250 ms and 10 s when the MUSIM UE indicated “NAS signalling connection release” or “Rejection of paging” in the UE request type IE of the EXTENDED SERVICE REQUEST message or CONTROL PLANE SERVICE REQUEST message; or indicated “NAS signalling connection release” in the UE request type IE of the TRACKING AREA UPDATE REQUEST message.

TABLE 6
Table 6 depicts EPS mobility management timers at the network side.

| | | | | | ON THE |
|---|---|---|---|---|---|
| TIMER | TIMER | | | | 1st, 2nd, 3rd, 4th |
| NUM. | VALUE | STATE | CAUSE OF START | NORMAL STOP | EXPIRY (NOTE 1) |
| T3413 | NOTE | EMM- | Paging procedure for | Paging procedure for | Network dependent |
| NOTE 8 | 2 | REGISTERED | EPS services | EPS services | |
| NOTE 10 | | | initiated | completed | |
| | | | | Paging procedure is | |
| | | | | aborted | |
| T3415 | NOTE | EMM- | Paging procedure for | Paging procedure for | Paging procedure |
| NOTE 8 | 6 | REGISTERED | EPS services | EPS services | aborted and the |
| NOTE 10 | | | initiated for a UE | completed | network proceeds as |
| | | | which the network | Paging procedure is | specified in |
| | | | accepted the request | aborted | 3GPP TS 23.401 |
| | | | to use eDRX and the | | [10] |
| | | | UE does not have a | | |
| | | | PDN connection for | | |
| | | | emergency bearer | | |
| | | | services | | |
| T3422 | 6 s | EMM- | DETACH | DETACH ACCEPT | Retransmission of |
| NOTE 7 | In WB- | DEREGISTERED- | REQUEST sent | received | DETACH |
| NOTE 9 | S1/CE | INITIATED | | | REQUEST |
| | mode, | | | | |
| | 24 s | | | | |
| T3447 | NOTE | All | UE transitions from | ATTACH ACCEPT | Allow the UE to |
| | 2 | | EMM- | or TRACKING | initiate a connection |
| | | | CONNECTED | AREA UPDATE | for transfer of |
| | | | mode to EMM-IDLE | ACCEPT without the | uplink user data. |
| | | | mode except when | T3447 value IE. At | |
| | | | UE was in EMM- | MME during inter- | |
| | | | CONNECTED | system change from | |
| | | | mode due to paging, | S1 mode to N1 mode. | |
| | | | attach without PDN | REGISTRATION | |
| | | | connection or | ACCEPT without the | |
| | | | tracking area update | T3447 value IE | |
| | | | request without | (defined in | |
| | | | “active” or | 3GPP TS 24.501 | |
| | | | “signalling active” | [54]). | |
| | | | flag set | CONFIGURATION | |
| | | | UE transitions from | UPDATE | |
| | | | 5GMM- | COMMAND with the | |
| | | | CONNECTED | T3447 value IE set to | |
| | | | mode to 5GMM- | zero or deactivated | |
| | | | IDLE mode except | defined in | |
| | | | when UE was in | 3GPP TS 24.501 [54]). | |
| | | | 5GMM- | At AMF during | |
| | | | CONNECTED | inter-system change | |
| | | | mode due to paging, | from N1 mode to S1 | |
| | | | REGISTRATION | mode defined in | |
| | | | REQUEST for initial | 3GPP TS 24.501 [54] | |
| | | | registration with | | |
| | | | Follow-on request | | |
| | | | indicator set to “No | | |
| | | | follow-on request | | |
| | | | pending”, or | | |
| | | | REGISTRATION | | |
| | | | REQUEST for | | |
| | | | mobility and | | |
| | | | periodic registration | | |
| | | | update with Follow- | | |
| | | | on request indicator | | |
| | | | set to “No follow-on | | |
| | | | request pending” and | | |
| | | | without Uplink data | | |
| | | | status IE included. | | |
| T3450 | 6 s | EMM- | ATTACH ACCEPT | ATTACH | Retransmission of |
| NOTE 7 | In WB- | COMMON- | sent | COMPLETE | the same message |
| NOTE 9 | S1/CE | PROC-INIT | TRACKING AREA | received | type, i.e. ATTACH |
| | mode, | | UPDATE ACCEPT | TRACKING AREA | ACCEPT, |
| | 18 s | | sent with GUTI | UPDATE | TRACKING |
| | | | TRACKING AREA | COMPLETE | AREA UPDATE |
| | | | UPDATE ACCEPT | received | ACCEPT or GUTI |
| | | | sent with TMSI | GUTI | REALLOCATION |
| | | | GUTI | REALLOCATION | COMMAND |
| | | | REALLOCATION | COMPLETE | |
| | | | COMMAND sent | received | |
| T3460 | 6 s | EMM- | AUTHENTICATION | AUTHENTICATION | Retransmission of |
| NOTE 7 | In WB- | COMMON- | REQUEST sent | RESPONSE | the same message |
| NOTE 9 | S1/CE | PROC-INIT | SECURITY MODE | received | type, i.e |
| | mode, | | COMMAND sent | AUTHENTICATION | AUTHENTICATION |
| | 24 s | | | FAILURE received | REQUEST |
| | | | | SECURITY MODE | or SECURITY |
| | | | | COMPLETE | MODE |
| | | | | received | COMMAND |
| | | | | SECURITY MODE | |
| | | | | REJECT received | |
| T3470 | 6 s | EMM- | IDENTITY | IDENTITY | Retransmission of |
| NOTE 7 | In | WB-COMMON- | REQUEST sent | RESPONSE received | IDENTITY |
| NOTE 9 | S1 mode, | PROC-INIT | | | REQUEST |
| | 24 s | | | | |
| Mobile | NOTE | All except EMM- | Entering EMM- | NS signalling | Network dependent, |
| reachable | 4 | DEREGISTERED | IDLE mode | connection | but typically paging |
| | | | | established | is halted on 1st |
| | | | | | expiry if the UE is |
| | | | | | not attached for |
| | | | | | emergency bearer |
| | | | | | services. |
| | | | | | Implicitly detach |
| | | | | | the UE which is |
| | | | | | attached for |
| | | | | | emergency bearer |
| | | | | | services. |
| Implicit | NOTE | All except EMM- | The mobile | NAS signalling | Implicitly detach |
| detach | 3 | DEREGISTERED | reachable timer | connection | the UE on 1st expiry |
| timer | | | expires while the | established | |
| | | | network is in EMM- | | |
| | | | IDLE mode | | |
| active | NOTE | All except EMM- | Entering EMM- | NAS signalling | Network dependent, |
| timer | 5 | DEREGISTERED | IDLE mode | connection | but typically paging |
| | | | | established | is halted on 1st |
| | | | | | expiry |

NOTE 1:
Typically, the procedures are aborted on the fifth expiry of the relevant timer. Exceptions are described in the corresponding procedure description.
NOTE 2:
The value of this timer is network dependent.
NOTE 3:
The value of this timer is network dependent. If ISR is activated, the default value of this timer is 4 minutes greater than T3423.
NOTE 4:
The default value of this timer is 4 minutes greater than T3412. If T3346 is larger than T3412 and the MME includes timer T3346 in the TRACKING AREA UPDATE REJECT message or SERVICE REJECT message, the value of the mobile reachable timer and implicit detach timer is set such that the sum of the timer values is greater than T3346. If the UE is attached for emergency bearer services, the value of this timer is set equal to T3412.
NOTE 5:
If the MME includes timer T3324 in the ATTACH ACCEPT message or TRACKING AREA UPDATE ACCEPT message and if the UE is not attached for emergency bearer services and has no PDN connection for emergency bearer services, the value of this timer is equal to the value of timer T3324.
NOTE 6:
The value of this timer is smaller than the value of timer T3-RESPONSE (see 3GPP TS 29.274 [16D]).
NOTE 7:
In NB-S1 mode, then the timer value shall be calculated as described in clause 4.7.
NOTE 8:
In NB-S1 mode, then the timer value shall be calculated by using an NAS timer value which is network dependent.
NOTE 9:
In WB-S1 mode, if the UE supports CE mode B and operates in either CE mode A or CE mode B, then the timer value is as described in this table for the case of WB-S1/CE mode (see clause 4.8).
NOTE 10:
In WB-S1 mode, if the UE supports CE mode B, then the timer value shall be calculated by using an NAS timer value which value is network dependent.

TABLE 7
Table 7 depicts EPS session management timers at the UE side.

| | | | | | ON THE |
|---|---|---|---|---|---|
| | | | | | 1st, 2nd, 3rd, 4th |
| TIMER | TIMER | | | | EXPIRY |
| NUM. | VALUE | STATE | CAUSE OF START | NORMAL STOP | (NOTE 1) |
| T3480 | 8 s | PROCEDURE | BEARER | ACTIVATE | Retransmission of |
| NOTE 2 | In WB- | TRANSACTION | RESOURCE | DEDICATED | BEARER |
| NOTE 3 | S1/CE | PENDING | ALLOCATION | EPS BEARER | RESOURCE |
| | mode, 16 s | | REQUEST sent | CONTEXT | ALLOCATION |
| | NOTE 4 | | | REQUEST | REQUEST |
| | | | | received or | |
| | | | | MODIFY EPS | |
| | | | | BEARER | |
| | | | | CONTEXT | |
| | | | | REQUEST | |
| | | | | received or | |
| | | | | BEARER | |
| | | | | RESOURCE | |
| | | | | ALLOCATION | |
| | | | | REJECT received | |
| T3481 | 8 s | PROCEDURE | BEARER | ACTIVATE | Retransmission of |
| NOTE 2 | In WB- | TRANSACTION | RESOURCE | DEDICATED | BEARER |
| NOTE 3 | S1/CE | PENDING | MODIFICATION | EPS BEARER | RESOURCE |
| | mode, 16 s | | REQUEST sent | CONTEXT | MODIFICATION |
| | NOTE 4 | | | REQUEST | REQUEST |
| | | | | received or | |
| | | | | MODIFY EPS | |
| | | | | BEARER | |
| | | | | CONTEXT | |
| | | | | REQUEST | |
| | | | | received or | |
| | | | | DEACTIVATE | |
| | | | | EPS BEARER | |
| | | | | CONTEXT | |
| | | | | REQUEST | |
| | | | | received or | |
| | | | | BEARER | |
| | | | | RESOURCE | |
| | | | | MODIFICATION | |
| | | | | REJECT received | |
| T3482 | 8 s | PROCEDURE | An additional PDN | ACTIVE | Retransmission of |
| NOTE 2 | In WB- | TRANSACTION | connection is | DEFAULT EPS | PDN |
| NOTE 3 | S1/CE | PENDING | requested by the UE | BEARER | CONNECTIVITY |
| | mode, 16 s | | which is not | CONTEXT | REQUEST |
| | NOTE 4 | | combined in attach | REQUEST | |
| | | | procedure | received or PDN | |
| | | | | CONNECTIVITY | |
| | | | | REJECT received | |
| T3492 | 6 s | PROCEDURE | PDN DISCONNECT | DEACTIVATE | Retransmission of |
| NOTE 2 | In WB- | TRANSACTION | REQUEST sent | EPS BEARER | PDN |
| NOTE 3 | S1/CE | PENDING | | CONTEXT | DISCONNECT |
| | mode, 14 s | | | REQUEST | REQUEST |
| | NOTE 4 | | | received or PDN | |
| | | | | DISCONNECT | |
| | | | | REJECT received | |
| T3493 | 4 s | PROCEDURE | REMOTE UE | REMOTE UE | Retransmission of |
| NOTE 2 | In WB- | TRANSACTION | REPORT sent | REPORT | REMOTE UE |
| NOTE 3 | S1/CE | PENDING | | RESPONSE | REPORT |
| | mode, 12 s | | | received | |
| | NOTE 4 | | | | |
| Back-off | | | defined in | | |
| timer | | | 3GPP TS 24.008 [13] | | |

NOTE 1:
Typically, the procedures are aborted on the fifth expiry of the relevant timer. Exceptions are described in the corresponding procedure description.
NOTE 2:
In NB-S1 mode, then the timer value shall be calculated as described in clause 4.7.
NOTE 3:
In WB-S1 mode, if the UE supports CE mode B and operates in either CE mode A or CE mode B, then the timer value is as described in this table for the case of WB-S1/CE mode (see clause 4.8).
NOTE 4:
In satellite E-UTRAN access, the value for WB-S1/CE mode shall be selected when satellite E-UTRAN RAT type is “WB-E-UTRAN(MEO)”, ” WB-E-UTRAN(GEO)”, “NB-IoT(MEO)”, “NB-IoT(GEO)”, “LTE-M(MEO)” or “LTE-M(GEO)”.

TABLE 8
Table 8 depicts EPS session management timers at the network side.

| | | | | | ON THE |
|---|---|---|---|---|---|
| | | | | | 1st, 2nd, 3rd, 4th |
| | TIMER | | | | EXPIRY |
| | VALUE | STATE | CAUSE OF START | NORMAL STOP | (NOTE 1) |
| T3485 | 8 s | BEARER | ACTIVATE | ACTIVATE | Retransmission |
| NOTE 2 | In WB- | CONTEXT | DEFAULT EPS | DEFAULT EPS | of the same |
| NOTE 3 | S1/CE | ACTIVE | BEARER CONTEXT | BEARER | message |
| | mode, 16 | PENDING | REQUEST sent | CONTEXT | |
| | NOTE 4 s | | ACTIVATE | ACCEPT | |
| | | | DEDICATED EPS | received | |
| | | | BEARER CONTEXT | or ACTIVATE | |
| | | | REQUEST sent | DEFAULT EPS | |
| | | | | BEARER | |
| | | | | CONTEXT | |
| | | | | REJECT | |
| | | | | received | |
| | | | | or ACTIVATE | |
| | | | | DEDICATED | |
| | | | | EPS BEARER | |
| | | | | CONTEXT | |
| | | | | ACCEPT | |
| | | | | received | |
| | | | | or ACTIVATE | |
| | | | | DEDICATED | |
| | | | | EPS BEARER | |
| | | | | CONTEXT | |
| | | | | REJECT | |
| | | | | received | |
| T3486 | 8 s | BEARER | MODIFY EPS | MODIFY EPS | Retransmission |
| NOTE 2 | In WB- | CONTEXT | BEARER CONTEXT | BEARER | of MODIFY |
| NOTE 3 | S1/CE | MODIFY | REQUEST sent | CONTEXT | EPS BEARER |
| | mode, 16 s | PENDING | | ACCEPT | CONTEXT |
| | NOTE 4 | | | received | REQUEST |
| | | | | or MODIFY EPS | |
| | | | | BEARER | |
| | | | | CONTEXT | |
| | | | | REJECT | |
| | | | | received | |
| T3489 | 4 s | PROCEDURE | ESM | ESM | Retransmission |
| NOTE 2 | In WB- | TRANSACTION | INFORMATION | INFORMATION | of ESM |
| NOTE 3 | S1/CE | PENDING | REQUEST sent | RESPONSE | INFORMATION |
| | mode, 12 s | | | received | REQUEST on |
| | NOTE 4 | | | | 1st and 2nd |
| | | | | | expiry only |
| T3495 | 8 s | BEARER | DEACTIVATE EPS | DEACTIVATE | Retransmission |
| NOTE 2 | In WB- | CONTEXT | BEARER CONTEXT | EPS BEARER | of |
| NOTE 3 | S1/CE | INACTIVE | REQUEST sent | CONTEXT | DEACTIVATE |
| | mode, 16 s | PENDING | | ACCEPT | EPS BEARER |
| | NOTE 4 | | | received | CONTEXT |
| | | | | | REQUEST |

NOTE 1:
Typically, the procedures are aborted on the fifth expiry of the relevant timer. Exceptions are described in the corresponding procedure description.
NOTE 2:
In NB-S1 mode, then the timer value shall be calculated as described in clause 4.7.
NOTE 3:
In WB-S1 mode, if the UE supports CE mode B and operates in either CE mode A or CE mode B, then the timer value is as described in this table for the case of WB-S1/CE mode (see clause 4.8).
NOTE 4:
In satellite E-UTRAN access, the value for WB-S1/CE mode shall be selected when satellite E-UTRAN RAT type is “WB-E-UTRAN(MEO)”, “WB-E-UTRAN(GEO)”, “NB-IoT(MEO)”, “NB-IoT(GEO)”, “LTE-M(MEO)” or “LTE-M(GEO)”.

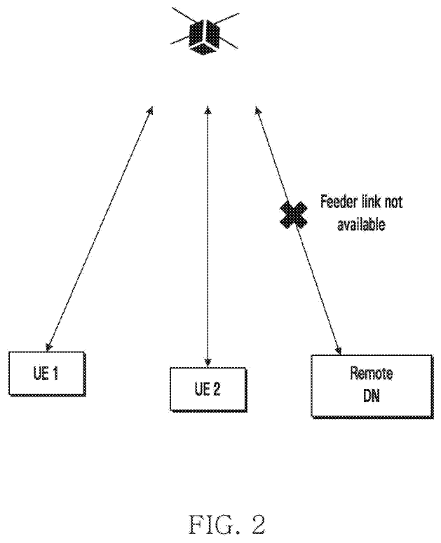

Consider an example scenario, wherein the feeder link is not available (as depicted in FIG. 2). When the feeder link is not available and the UE is not registered in current TAI or has lost the registration context/NW Context, the UE is unable to trigger registration/attach procedure. In another example scenario, if the satellite does not have UE information/UE context/UE Subscription details, the satellite is not able to handle the Attach Request/Registration Request received from the UE. It is further not defined as how the round trip time between the UE and the MME/AMF on-board the satellite and UDM/HSS on ground is handled, when the UE is in a location where there is for e.g., no terrestrial network and Satellite serving the UE has no feeder link available. Hence, there is a need for systems and method which will address the above-mentioned drawback(s), among others. Various example embodiments disclose methods and systems for managing satellite communication using a store and forward (S&F) service with at least one network node onboard a satellite. Various embodiments enable the UE to trigger a registration/attach procedure, when a feeder link is not available, and the UE is not registered in current TAI or has lost the registration context/NW Context.

Various embodiments herein enable the satellite to handle the Attach Request/Registration Request received from a UE, wherein the satellite does not have information/context/subscription details of the UE. Various embodiments handle a round trip time between the UE and the MME/AMF on-board the satellite and UDM/HSS on ground or other network function or core network elements on the ground, when the UE is in a location where there is no terrestrial network and Satellite serving the UE has no feeder link available. Various embodiments provide an estimated delivery time to User Equipment (UE) in the S&F service, wherein the estimated delivery time is the minimum time required for the data/signaling to reach the ground station. Various embodiments disclose methods and systems in which the UE is configured to be served by a single satellite and performs the attachment procedure directly with the satellite.

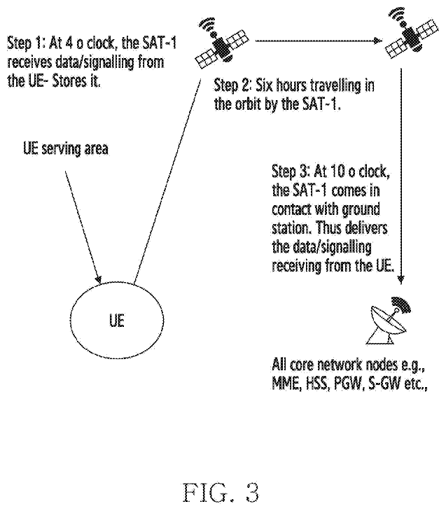

Various embodiments herein disclose an architecture for satellite communication network with all NFs onboard, wherein the UE is served by the single satellite and registers with the serving satellite that holds the UE context. Various embodiments herein disclose methods and systems for managing satellite communication using a store and forward (S&F) service with at least one network node onboard the satellite. Various embodiments herein relate to providing an estimated delivery time to User Equipment (UE), wherein the estimated delivery time is the minimum time required for the data signaling to reach the ground station. Referring now to the drawings, and more particularly to FIGS. 3 through 8, where similar reference characters denote corresponding features consistently throughout the figures, there are shown various example embodiments. The following definitions and abbreviations may be referred to herein: 3GPP: Third Generation Partnership Project
4G-GUTI: 4G-Globally Unique Temporary Identifier
5G-BRG: 5G Broadband Residential Gateway
5GC: 5G Core
5GCN: 5G Core Network
5G-CRG: 5G Cable Residential Gateway
5G-GUTI: 5G-Globally Unique Temporary Identifier
5GMM: 5G Mobility Management
5G-RG: 5G Residential Gateway
5GS: 5G System
5GSM: 5GS Session Management
5G-S-TMSI: 5G S-Temporary Mobile Subscription Identifier
5G-TMSI: 5G Temporary Mobile Subscription Identifier
5QI: 5G QoS Identifier
ACS: Auto-Configuration Server
AKA: Authentication and Key Agreement
A-KID: AKMA Key Identifier
AKMA: Authentication and Key Management for Applications
AMBR: Aggregate Maximum Bit Rate
AMF: Access and Mobility Management Function
APN: Access Point Name
ARP: Allocation and Retention Policy
AS: Access Stratum
A-TID: AKMA Temporary Identifier
ATSSS: Access Traffic Steering, Switching and Splitting
AUSF: Authentication Server Function
CAG: Closed access group
CAG ID: Closed Access Group Identifier
CHAP: Challenge Handshake Authentication Protocol
CU: Centralized Unit
DC: Discontinuous Coverage
DisCo: Discontinuous Coverage
DL: Downlink
DND: Do not Disturb
DRX: Discontinuous Reception
DU: Distributed Unit
eDRX: Extended Discontinuous Reception
EHPLMN: Equivalent Home Public Land Mobile Network
EMM: EUTRA Mobility Management
eNB: Evolved Node-B
eNPN: Enhanced Non-Public Networks
EPC: Evolved Packet Core
EPLMN: Equivalent Public Land Mobile Network
EPS: Evolved Packet System
eSIM: embedded Subscriber Identity Module
1E-UTRA: Evolved Universal Mobile Telecommunication Access
EUTRAN: Evolved Universal Mobile Telecommunication Access Network
FPLMN: Forbidden Public Land Mobile Network
FR: Frequency Range
GEO: Geostationary Orbit
GERAN: GSM Edge Radio Access Network
GERAN EC-GSM-IoT: GSM Edge Radio Access Network Extended Coverage-GSM-Internet of Things
gNB: Next generation Node-B
gNB-CU: Next generation Node-B Control Unit
gNB-DU: Next generation Node-B Distributive Unit
GPRS: General Packet Radio Service
GPS: Global Positioning System
GSM: Global System for Mobile Communication
HPLMN: Home Public Land Mobile Network
IAB: Integrated access and backhaul
IAB-UE: The part of the IAB node that supports the Uu interface towards the IAB-donor or another parent IAB-node (and thus manages the backhaul connectivity with either PLMN or SNPN it is registered with) is referred to as an IAB-UE.
LADN: Local Area Data Network
LCS: Location services
LEO: Low Earth Orbit
MBSR: Mobile Base Station Relay
MCC: Mobile Country Code
MCS: Mission Critical Service
ME: Mobile Equipment
MEC: Multi-Access Edge Computing
MEO: Medium Earth Orbit
MICO: Mobile Initiated Communication Only
MINT: Minimization of service interruption
MME: Mobility Management Entity
MNC: Mobile Network Code
MPS: Multimedia Priority Service
MS: Mobile Station. The disclosure makes no distinction between MS and UE.
NAS: Non-Access Stratum
NB-S1 Mode: Narrow Band with S1 Interface
NGAP: Next Generation Application Protocol
NG-RAN: Next Generation Radio Access Network
NPN: Non-Public Networks
NR: New Radio
NTN: Non Terrestrial Networks
NW: Network
OOS: Out of Service
OS Upgrade: Operating System Upgrade
PDN: Packet Data Network
PDU: Packet Data Unit
PLMN ID: Public Land Mobile Network Identity
PSM: Power Saving Mode
QoS: Quality Of Service
RAT: Radio Access Technology
RPLMN: Registered Public Land Mobile Network
RRC: Radio Resource Control
RU: Registration Update
SAT: Satellite
Satellite: An artificial body placed in orbit round the earth or moon or another planet in order to collect information or for communication.
Satellite Constellation: A group of satellites, placed in orbit round the earth or moon or another planet in order to collect information or for communication.
Service User: An individual who has received a priority level assignment from a regional/national authority (i.e., an agency authorised to issue priority assignments) and has a subscription to a mobile network operator
SIM: Subscriber Identity Module
SNPN: Standalone Non-Public Networks
SUCI: Subscription Concealed Identifier
SW: Software
TAC: Tracking Area Code
TAI: Tracking Area Identity
TAU: Tracking Area Update
TER: Terrestrial
TN: Terrestrial Networks
UCU: UE Configuration Update
UDM: Unified Data Management Function
UE: User Equipment
UL: Uplink
ULI: User Location Information
UPU: UE Parameters Update
USIM: Universal Subscriber Identification Module
Uu: The radio interface between the UE and the Node B
VMR: Vehicle Mounted Relay
VPLMN: Visited Public Land Mobile Network
WB-S1 Mode: Wide Band with S1 Interface
Visited PLMN (VPLMN): This is a PLMN different from the HPLMN (if the EHPLMN list is not present or is empty) or different from an EHPLMN (if the EHPLMN list is present).
Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
Available PLMN: PLMN(s) in the given area which is/are broadcasting capability to provide wireless communication services to the UE.
Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
EHPLMN: Any of the PLMN entries contained in the Equivalent HPLMN list.
Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list, then it shall be treated as a Visited PLMN for PLMN selection purposes.
Home PLMN: This is a PLMN where the MCC and MNC of the PLMN identity match the MCC and MNC of the IMSI.
Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.
Registration: This is the process of camping on a cell of the PLMN or the SNPN and doing any necessary LRs.
UPLMN: PLMN/access technology combination in the “User Controlled PLMN Selector with Access Technology” data file in the SIM (in priority order).
OPLMN: PLMN/access technology combination in the “Operator Controlled PLMN Selector with Access Technology” data file in the SIM (in priority order) or stored in the ME (in priority order).
Feeder Link: Feeder link can be defined as a wireless link between the NTN
Gateway and the satellite.
Service Link: Service link is the radio link between a user equipment (UE) and a Satellite.
Serving satellite: A satellite providing the satellite access to a UE. In the case of NGSO (Non-Geostationary Satellite Orbit), the serving satellite is always changing due to the nature of the constellation.
Store & Forward Satellite operation: in the context of this study, it is an operation mode of a 5G system with satellite-access where the 5G system can provide some level of service (in storing and forwarding the data) when satellite connectivity is intermittently/temporarily unavailable, e.g. to provide communication service for UEs under satellite coverage without a simultaneous active feeder link connection to the ground segment.
S&F data retention period: it is the data storage validity period for the 5G system with satellite access supporting store and forward operation (e.g. after which undelivered data stored is being discarded).
UE-Satellite-UE Communication: for the 5G system with satellite access, it refers to the communication between UEs under the coverage of one or more serving satellites, using satellite access without going through the ground segment.

Examples of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command; UE PARAMETERS UPDATE command; and so on.

The term 5GMM sublayer states in this embodiment are at least one of the below:
1) 5GMM-NULL
2) 5GMM-DEREGISTERED
a) 5GMM-DEREGISTERED.NORMAL-SERVICE
b) 5GMM-DEREGISTERED.LIMITED-SERVICE
c) 5GMM-DEREGISTERED.ATTEMPTING-REGISTRATION
d) 5GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED
3) 5GMM-REGISTERED-INITIATED
4) 5GMM-REGISTERED
a) 5GMM-REGISTERED.NORMAL-SERVICE
b) 5GMM-REGISTERED.NON-ALLOWED-SERVICE
c) 5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED
5) 5GMM-DEREGISTERED-INITIATED
6) 5GMM-SERVICE-REQUEST-INITIATED

In this embodiment, the term EMM sublayer states are at least one of the below:
1) EMM-NULL
2) EMM-DEREGISTERED
a) EMM-DEREGISTERED.NORMAL-SERVICE
b) EMM-DEREGISTERED.LIMITED-SERVICE
c) EMM-DEREGISTERED.ATTEMPTING-TO-ATTACH
d) EMM-DEREGISTERED.PLMN-SEARCH
e) EMM-DEREGISTERED.NO-IMSI
f) EMM-DEREGISTERED.ATTACH-NEEDED
g) EMM-DEREGISTERED.NO-CELL-AVAILABLE
h) EMM-DEREGISTERED.eCALL-INACTIVE
3) EMM-REGISTERED-INITIATED
4) EMM-REGISTERED
a) EMM-REGISTERED.NORMAL-SERVICE
b) EMM-REGISTERED.ATTEMPTING-TO-UPDATE
c) EMM-REGISTERED.LIMITED-SERVICE
d) EMM-REGISTERED.PLMN-SEARCH
e) EMM-REGISTERED.UPDATE-NEEDED
f) EMM-REGISTERED.NO-CELL-AVAILABLE
g) EMM-REGISTERED.ATTEMPTING-TO-UPDATE-MM
h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT as defined in this embodiment can be one of the following: NG-RAN, 5G, 4G, 3G, 2G, EPS, 5GS, NR, NR in unlicensed bands, NR (LEO) satellite access, NR (MEO) satellite access, NR (GEO) satellite access, NR (OTHERSAT) satellite access, NR RedCap, E-UTRA, E-UTRA in unlicensed bands, NB-IoT, WB-IoT, LTE-M, and so on.

5GS registration types can be initial registration, mobility registration updating, periodic registration updating, emergency registration, SNPN onboarding registration, disaster roaming initial registration; disaster roaming mobility registration updating, and so on.

Not setting the registration type to disaster roaming initial registration or disaster roaming mobility registration updating may refer, for example, to 5GS registration type is set to value other than “disaster roaming initial registration” or ““disaster roaming mobility registration updating” at least one of: initial registration, mobility registration updating, periodic registration updating, emergency registration, SNPN onboarding registration, and so on.

PLMN selection as per 23.122 without RPLMN:

The MS selects and attempts registration on any PLMN/access technology combinations, if available and allowable, in the following order:
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

PLMN selection as per 23.122 with RPLMN:

The MS selects and attempts registration on any PLMN/access technology combinations, if available and allowable, in the following order:
either the RPLMN or the Last registered PLMN;
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

For a 5G system with satellite access, the following requirements apply:
The 5G system shall support service continuity between NR terrestrial access network and NR satellite access networks owned by the same operator or owned by 2 different operators having an agreement.

The NTN and TN could either operate in two different frequency bands (e.g. FR1 vs FR2), or in same frequency band (e.g. FR1 or FR2).

The Satellite System or Satellite Access as used or defined in this embodiment is applicable for both 5G system with satellite access and/or 4G system with satellite access or any RAT with satellite access.

The terms Satellite 3GPP access, Satellite access, Satellite Access Network, NR Satellite Access Network, Satellite NG-RAN Access Technology and NR Satellite access have been interchangeably used and have the same meaning.

The disclosed methods and systems may be explained using NR satellite access or Satellite NG-RAN Access Technology as an example and is not restricted or limited to NR Satellite access. However, the various embodiments may also be applicable for Satellite E-UTRAN access Technology, NB (Narrow Band)-S1 mode or WB (Wide Band)-S1 mode via satellite E-UTRAN access and/or NB-IoT (NarrowBand Internet Of Things) or WB-IoT (WideBand Internet Of Things) Satellite Access/Architecture.

Embodiments for NR (5GC) are also applicable to legacy RATs like E-UTRA/LTE, the corresponding CN entities needs to be replaced by LTE entities for e.g. AMF with MME, g-nodeB with e-nodeB, UDM with HSS etc. But principles of the solution remains same.

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The Network used in is the disclosure may be explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in the disclosure are shown as an example. The messages could be any signalling messages between UE and the Network Functions/Entities or between different Network functions/entities.

The term area/location/geographical area may refer to any of cell/cell ID, TAC/TAI, PLMN, MCC/MNC, Latitude/longitude, CAG cell or any geographical location/coordinate.

The disclosure may be explained using NR access or NG-RAN Access Technology as an example and is not restricted or limited to NR access only. However, the disclosure may also be applicable for E-UTRAN access Technology, NB (Narrow Band)-S1 mode or WB (Wide Band)-S1 mode via E-UTRAN access and/or NB-IoT (NarrowBand Internet Of Things) or WB-IoT (WideBand Internet Of Things) Access/Architecture.

The disclosure for NR (5GC) may also be applicable to legacy RATs like E-UTRA/LTE, the corresponding CN entities needs to be replaced by LTE entities for e.g. AMF with MME, g-nodeB with e-nodeB, UDM with HSS etc. But principles of the solution remain same.

The Network used in is the disclosure may be explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in the disclosure are shown as an example. The messages could be any signalling messages between UE and the Network Functions/Entities or between different Network functions/entities.

The terms camp and register are used interchangeably and have the same meaning.

The terms wait timer, DisCo wait timer, Discontinuous Coverage wait timer, Random timer, Random wait timer, DCW Timer are all used interchangeably and have the same meaning.

The terms wait range, Disco Wait Range, Discontinuous Coverage Wait Range, DCW Range are all used interchangeably and have the same meaning.

The term area as used in this embodiment may refer to any of cell/cell ID, TAC/TAI, PLMN, MCC/MNC, Latitude/longitude, any CAG/CAG identifier or any geographical location/coordinate.

For the list of possible NAS messages please refer to 3GPP TS 24.501 or 3GPP TS 24.301, for list of AS messages please refer to 3GPP TS 38.331 or 3GPP TS 36.331

The cause names in this embodiment are for illustration purpose and it can have any name. The non access stratum (NAS) messages and access stratum (AS) messages described in this embodiment is only for illustration purpose it can be any NAS or AS messages as per defined protocol between UE and AMF/MME or UE and gNB (NG-RAN/any RAN node)/eNB.

In the disclosure, the term Satellite is used interchangeably with 5G or 4G system with satellite access and is used to represent any Satellite(s) or constellation of Satellites(s) or any aerial body/satellite in any of the Satellite orbits (for ex-LEO/MEO/GEO/HEO etc) or any 5G system with Satellite Access or 4G System with Satellite Access or any RAN Entity or Core Network Entity or any Network Function(s) associated with the Satellite Access/RAT/PLMN/Network.

The terms MME/AMF-Onboard and MME/AMF-lighter are used interchangeably in this embodiment and have the same meaning.

The terms SAT and Satellite are used interchangeably in this embodiment and have the same meaning.

The disclosure provides methods and systems for enabling the UE to trigger a registration/attach procedure, when the feeder link is not available, and the UE is not registered in current TAI or has lost the registration context/NW Context.

The disclosure provides methods and systems for enabling the satellite to handle the Attach Request/Registration Request received from a UE, wherein the satellite does not have information/context/subscription details of the UE.

The disclosure provides methods and systems for handling the round trip time between the UE and the MME/AMF on-board the satellite and UDM/HSS on ground or other network function or core network elements on the ground, when the UE is in a location where there is no terrestrial network and Satellite serving the UE has no feeder link available.

The disclosure provides methods and systems for managing satellite communication using a store and forward (S&F) service with at least one network node onboard the satellite. The UE can determine whether the network supports S&F service and initiates at least one Non-Access Stratum (NAS) procedure with the network, wherein the UE determines at least one new value of a timer based on at least one estimated delivery time received from a core network node.

In an embodiment, the UE can be served by a single satellite and can perform the attachment procedure directly with the satellite. Embodiments herein disclose an architecture for a satellite communication network with all NFs onboard the satellite, wherein the UE is served by a single satellite and registers only with the serving satellite that holds the context of UE.

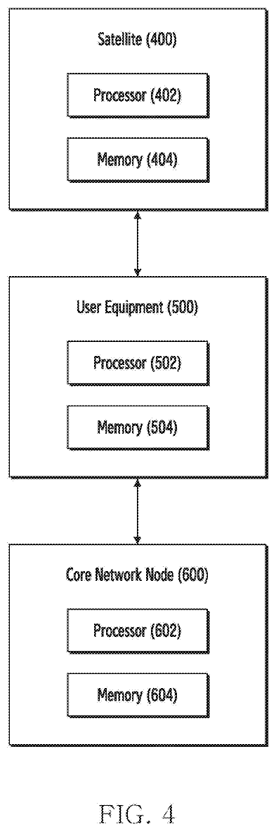

In an embodiment, the satellite 400 (see, e.g., FIG. 4) comprises at least one NF (on-board the satellite). Examples of the NF can be, but are not limited to, an Evolved Node (eNodeB), a Access and Mobility Management Function (AMF), a Home Subscriber Server (HSS), a Mobility Management Entity (MME), a Serving Gateway (S-GW), a Service Capability Exposure Function (SCEF), a Packet Data Network Gateway (P-GW), a Policy Control Function (PCF), a Data Network (DN), an Application Function (AF), a Policy and Charging Rules Function (PCRF), and any other NF, which are present in terrestrial networks. This is also called as whole EPC or 5GC onboard the satellite. As illustrated in FIG. 4, the satellite 400 comprises at least one onboard NF to support a store and forward (S&F) registration procedure. These NFs can be either full-featured or lighter versions, specifically designed to handle Non-Access Stratum (NAS) procedures like attachment, registration, and service requests, without the immediate need for communication with a ground station.

The UE attempts to register or attach to the network through the satellite, and the onboard core network entities manage the procedure. The satellite may process one or more requests for attachment and registration in the store and forward mode, even when the satellite is not connected to the ground station. Therefore, the onboard core network node/entities store the data sent by the UE. The data is held onboard the satellite until the satellite is able to connect with the ground station, at which point the data is forwarded to the Application Function (AF) or Data Network (DN) located on the ground.

Thereby, allowing the satellite to complete the attachment process without requiring immediate assistance from the ground station. The disclosure may enable the satellite to autonomously manage registration and communication, making it possible to handle these tasks in remote areas or during periods when there is no direct connection between the satellite and the ground station. The satellite performs autonomous operations, where the satellite can manage registration and other NAS procedures independently, and can store and forward data, ensuring communication continuity even when the satellite-ground connection is intermittent.

FIG. 3 is a diagram illustrating an example scenario wherein the estimated delivery time is provided to the UE in the S&F service, allowing the UE to determine a new value for the timer according to various embodiments. As illustrated in FIG. 3, the network determines whether the UE (e.g., 500 in FIG. 4) is in S&F service. On identifying that the UE (500) is in S&F service, the Mobility Management Entity (MME) of the network may provide the UE (500) with the estimated delivery time while performing the procedures that may include, but are not limited to, the attach accepts, Tracking Area Update (TAU) accept, or service accept messages. The estimated delivery time is the minimum time or it can be estimated maximum time or it can be time required for the data/signaling to reach the ground network in the S&F operation. The term reach the ground station implies that the signaling/data to reach the ground network which can be at least one core network node like MME, AMF, SMF, UPF, S-GW, P-GW, SCEF, data network (DN) etc., or it can be at least one application server or application function or any other node which is on the ground network.

For example, as illustrated in FIG. 3, step 1 shows the UE (500) sending data/signaling to the network onboard the satellite, which stores the data because the feeder link to the ground network is not available. In step 2, the satellite moves to an area where it can connect to the ground network. In step 3, after approximately six hours (for example), the satellite moves to a location, where it can establish the feeder link to the ground network, and the data/signaling is sent to the ground network. Therefore, it will take at least six hours to send the data/signaling to the ground network, referred to as the estimated delivery time. Similarly, it may take another six hours to respond to the NAS signaling/data sent to the ground network, which is referred to as the round-trip time (RTT).

Thus, the estimated delivery time is six hours, and the round-trip time is twelve hours. Based on the received estimated delivery time and round-trip time, the UE (500) adjusts its timers, which may include, but are not limited to, the Short Message Service (SMS) acknowledgment timer, such as the Control Plane Acknowledgement (CP-ACK), the Relay Protocol Acknowledgment (RP-ACK) timer, data acknowledgment timers, and other NAS protocol timers. The UE (500) also provides the updated timer values to the application layer so that the application layer can adjust its own timer settings. The new timer value is calculated as the old timer value along the Round-Trip Time (RTT) provided by the network to the UE (500).

According to an embodiment the UE (500) can determine the estimated delivery time of signaling or data sent by the UE (500) to the ground station. The UE (500) can define the protocol for when to expect a response from the network, based on the estimated delivery time. Therefore, the estimated delivery time can determine whether it can send data to the application server. For example, if the data is valid for two hours, but it would take six hours to send, it may not be practical for the application to send such data to the server.

The estimated delivery time can adjust the expected response time and the application layer protocol to account for delays caused by the S&F operation.

FIG. 4 is a block diagram illustrating example configurations and interactions of the satellite (400) with the UE (500) and a core network node (600) in the satellite communication according to various embodiments. The satellite (400) can interact with the UE (500) using satellite communication. The satellite 400 comprises a processor (e.g., including processing circuitry) 402 and a memory 404. The UE 500 comprises a processor (e.g., including processing circuitry) 502, and a memory 504. The core network node 600 comprises a processor (e.g., including processing circuitry) 602, and a memory 604.

The term “satellite” may refer, for example, to at least one of the NFs or gNB/eNB that is onboard from a 3GPP perspective. For example, when the UE (500) sends data to the satellite, it implies that data is sent to one of NFs or gNB (generally a node of the 3GPP system) that is onboard the satellite. Similarly, when the satellite sends the data, one of the NFs or gNB (generally a node of the 3GPP system) onboard the satellite can send data to the UE or to the NF/3GPP node on the ground.

The term “satellite access” can be applicable to both 5G networks and/or 4G networks, or Radio Access Technology (RAT). The terms “satellite 3rd Generation Partnership Project (3GPP) access”, “satellite access”, “satellite access network”, “NR satellite access network”, “satellite Next Generation Radio Access Network (NG-RAN) Access Technology”, and “NR satellite access” are used interchangeably and have the same meaning.

In an embodiment as disclosed herein, the satellite architecture is applicable to, may include, but are not limited to, a Satellite Evolved Universal Terrestrial Radio Access Network (E-UTRAN) access Technology, a Narrowband (NB)-S1 mode, a Wideband (WB)-S1 mode via Satellite E-UTRAN access, a Narrowband Internet of Things (NB-IoT), and a Wideband Internet of Things (WB-IoT) Satellite Access/Architecture.

The satellite architecture, as defined for NR (5G Core Network) is applicable to, may include, but are not limited to, legacy RATs like Evolved Universal Terrestrial Radio Access (E-UTRA)/Long-Term Evolution (LTE), with the corresponding Core Network (CN) entities needing to be replaced by LTE entities, such as an Access and Mobility Management Function (AMF) with the Mobility Management Entity (MME)/AMF, a gNodeB (gNB) with eNodeB (eNB), and a Unified Data Management (UDM) with Home Subscriber Server (HSS), so on.

The term “store and forward operation” may refer, for example, to an operation mode in the 5G network, wherein the network can provide some level of service (by storing and forwarding data) when satellite connectivity is intermittently/temporarily unavailable. For example, the operation mode can provide communication service for UEs under satellite coverage without a simultaneous active feeder link connection to the ground segment.

The UE 500 referred to herein may be an electronic device/user device that is used by the user to connect, interact, and/or control the operations of the plurality of other devices using a 3GPP network. Examples of the UE 500 may include, but are not limited to, a smartphone, a mobile phone, a video phone, a computer, a tablet personal computer (PC), a laptop, a wearable device, a personal digital assistant (PDA), an IoT device, or any other device that may use a 3GPP network.

The processor 502 may include one or a plurality of processors. The one or a plurality of processors may be a general-purpose processor, such as a central processing unit (CPU), an application processor (AP), or the like, a graphics-only processing unit such as a graphics processing unit (GPU), a visual processing unit (VPU), and/or an Artificial Intelligence (AI)-dedicated processor such as a neural processing unit (NPU). Thus, the processor 502 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. This description of the processor 502 applies equally to the processors 402 and 602 of the satellite and core network, respectively.

The memory 504 referred herein include at least one type of storage medium, from among a flash memory type storage medium, a hard disk type storage medium, a multi-media card micro type storage medium, a card type memory (for example, an SD or an XD memory), random-access memory (RAM), static RAM (SRAM), read-only memory (ROM), electrically erasable programmable ROM (EEPROM), programmable ROM (PROM), a magnetic memory, a magnetic disk, or an optical disk.

The core network node 600 refers to a central component in a telecommunications network responsible for managing and routing data and signaling between the UE (500) and various network elements. The core network node 600 can handle functions, which may include but are not limited to, mobility management, session management, and data transport. Examples of core network nodes in Long-Term Evolution (LTE) may include, but are not limited to the Mobility Management Entity (MME), Home Subscriber Server (HSS), Serving Gateway (SGW), Packet Data Network Gateway (PGW), and Access and Mobility Management Function (AMF). These nodes ensure proper communication, authentication, and delivery of data between the UE and the network. The core network nodes in Fifth Generation (5G) network may include, but are not limited to Access and Mobility Management Function (AMF), Session Management Function (SMF), User Plane Function (UPF), Unified Data Management (UDM), Authentication Server Function (AUSF), Policy Control Function (PCF), Network Exposure Function (NEF), Network Slice Selection Function (NSSF), and so on.

In an embodiment as disclosed herein, the UE (500) on determining that the network supports the S&F service, may initiate at least one NAS procedure with the network. The UE determines at least one new value of the timer based on at least one estimated delivery time received from the core network node. The NAS procedure initiated by the UE comprises one of an attach procedure, a registration procedure, a service request procedure, and a detach procedure. The timer comprises one of an application timers, a mobile reachability timer, a Short Message Service Control Protocol (SMS-CP) acknowledgement timer, and a Short Message Service Relay Protocol (SMS-RP) timer. The core network node onboard the satellite determines the estimated delivery time based on at least one of a current location of the UE, number of deployed satellites, distance of a ground station from the UE serving area, and so on.

In an embodiment as disclosed herein, the core network node can determine that at least one Non-Access Stratum (NAS) procedure initiated by the UE cannot be completed due to S&F operation, wherein the core network node is onboard the network. The core network node can provide the estimated delivery time to the UE, wherein the estimated delivery time is the minimum time for the data and signaling to reach a ground station. In the S&F operation, the UE is provided with a level of service, by at least one of storing and forwarding the data or NAS signaling for a period of time. The satellite serving the UE reaches a geographical location through a service link/feeder link.

In an embodiment as disclosed herein, on identifying that the UE is in S&F operation, the MME of the network may provide UE with the estimated delivery time while performing the procedures that may include, but are not limited to, the attach accepts, Tracking Area Update (TAU) accept, or service accept messages. The estimated delivery time is the minimum time required for the data/signaling to reach the ground network in the S&F operation.

For example, the UE sends data signaling at 4 PM to the network onboard the satellite. The network can store the data because it cannot deliver to the ground station as the feeder link is not available. After six hours, the satellite moves to an area where it can connect to the ground network, e.g., the feeder link is established, and the data/signaling is sent to the ground network. Therefore, it will take at least six hours to send the data/signaling to the ground network, which is referred to as the estimated delivery time. Similarly, it may take another six hours to receive a response to the NAS signaling/data sent to the ground network. Thus, the estimated delivery time is six hours, and the round-trip time is twelve hours.

In an embodiment as disclosed herein, the UE based on the received estimated delivery time and round-trip time (RTT), adjusts its timers, may include, but are not limited to the SMS acknowledgment timer (CP-ACK), RP-ACK timer, data acknowledgment timers, and other timers for NAS protocols. The UE provides the updated timer values to the application layer so that the application layer can adjust its own timer settings accordingly. The new timer value is calculated as the old timer value along with the RTT provided by the network to the UE

The term “feeder link/service link” may refer, for example, to communication pathway between the satellite (which hosts various core network functions) and the ground-based Data Network (DN) or Application Function (AF). The feeder link is essential for transmitting data between the satellite and terrestrial networks, enabling the flow of information from the User Equipment (UE) to the broader network infrastructure.

The satellite 400 continuously checks for the availability of the feeder link. On identifying that the feeder link is available, the satellite 400 can transmit the data stored to the Data Network (DN). Therefore, the process ensures that the data received from the UE is not lost and is transmitted to the DN as soon as the feeder link is available. Therefore, ensures that the user data is efficiently and securely handled, in satellite communications.

In an embodiment as disclosed herein, the term “signals” refer to at least one of the signaling message e.g. NAS/AS signaling message or the user data (also called as data/application data)

In an embodiment as disclosed herein, the architecture for Evolved Packet System (EPS), with the onboard network entities/NFs may comprise a proxy Data Network on board the satellite to store the data received from the UE or data to be sent to the UE.

The NFs on board the satellite ensure that all UE contexts and timers are handled by the same satellite. The UE can perform attach or other NAS procedures without the satellite needing to connect to the ground station. When the feeder link is not available, any of the CN entities (on board the satellite, e.g., S-GW/P-GW) store the data received from the UE. If both the feeder link and service link are available, the S-GW or another entity on board the satellite forwards/sends the data received from the UE to the P-GW or actual Data Network (Remote DN) on the ground e.g. to the entities available on the ground network.

The CN entity, which stores the data on the satellite, also forwards the data it has saved earlier to the actual DN on the ground (either directly or via the P-GW) once the feeder link is available. Similarly, any signaling data (control plane data) sent by the UE for the AF on the ground may be stored by any of the CN entities on board the satellite in the absence of a feeder link. The CN entity, which has stored the signal/data, delivers the stored messages to the ground station (AF situated on the ground) once the feeder link is established.

In an embodiment as disclosed herein, the satellite 400 comprises one or more core network node to support the store and forward (S&F) registration procedure. The core network node may have full capability or be lighter versions, with the necessary capabilities to handle registration and other NAS/AS procedures on board.

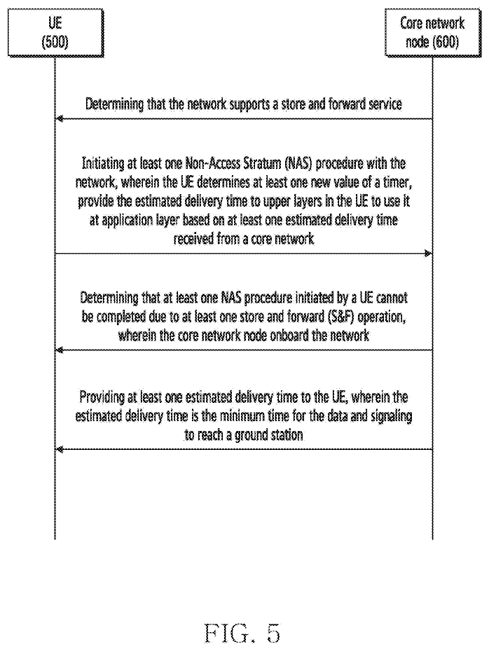

FIG. 5 is a signal flow diagram illustrating an example process of managing satellite communication using the S&F service with at least one network node onboard the satellite and the UE, according to various embodiments.

As illustrated in FIG. 5, the method for managing satellite communication using the store and forward (S&F) service with at least one network node onboard the satellite, the method comprising: determining, by a User Equipment (UE) (500), that a network supports the store and forward service; and initiating, by the UE (500), at least one Non-Access Stratum (NAS) procedure with the network, wherein the UE determines at least one new value of a timer based on at least one estimated delivery time received from a core network node.

The NAS procedure initiated by the UE comprises one of an attach procedure, a registration procedure, a service request procedure, and a detach procedure, the timer comprises one of an application timer, a mobile reachability timer, a Short Message Service Control Protocol (SMS-CP) acknowledgement timer, and a Short Message Service Relay Protocol (SMS-RP) timer. The core network node onboard the satellite determines the estimated delivery time based on at least one of a current location of the UE, number of deployed satellites, and distance of a ground station from the UE serving area.

The method comprises: determining by a core network node 600, that at least one Non-Access Stratum (NAS) procedure initiated by a User Equipment (UE) cannot be completed due to at least one store and forward (S&F) operation, wherein the core network node is onboard the network; and providing, by the core network node, at least one estimated delivery time to the UE, wherein the estimated delivery time is the minimum time for the data and signaling to reach a ground station.

In the at least one S&F operation, the UE is provided with a level of service, by at least one of storing and forwarding the data or NAS signaling for a period of time; and the satellite serving the UE reaches a geographical location through a service link. The core network node comprises one of a Mobility Management Entity (MME), and an Access Mobility Management Function (AMF). The core network node onboard the satellite comprises at least one of a Next Generation Node B (gNB), the AMF, the MME, a Serving Gateway (S-GW), a User Plane Function (UPF), a Policy Control Function (PCF), a Network Exposure Function (NEF), and a Proxy Data Network (Proxy-DN).

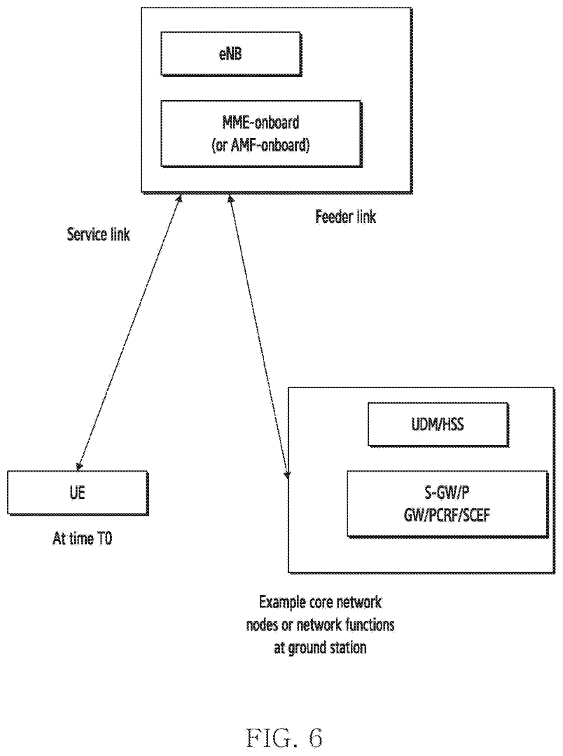

FIG. 6 is a diagram illustrating an example architecture of the satellite with the feeder link and service link available while interacting with core network node according to various embodiments. As illustrated in FIG. 6, the satellite with the MME-onboard or AMF on-board or any other network entity to support S&F registration/attach procedure. Other network entities may or may not be onboard.

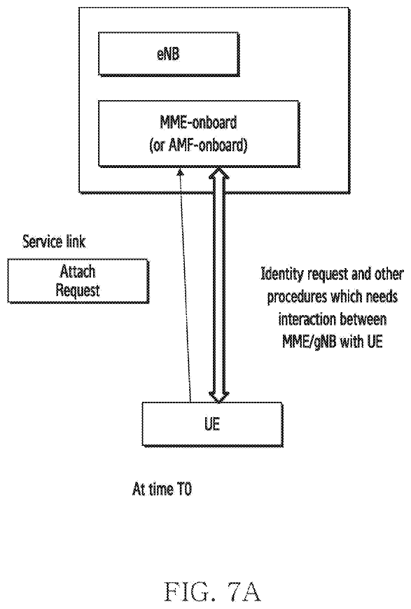

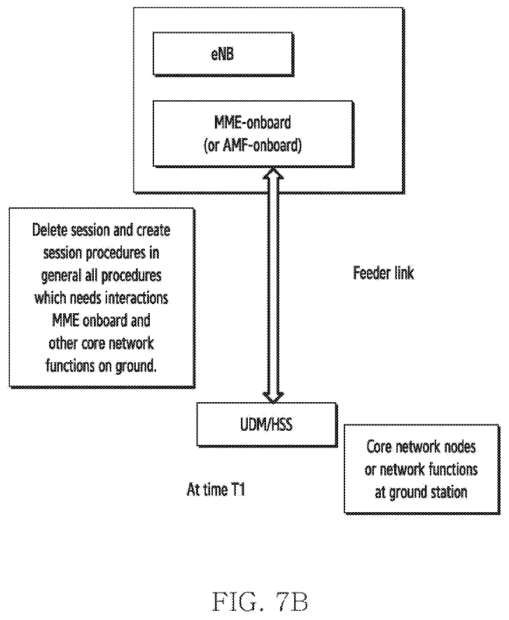

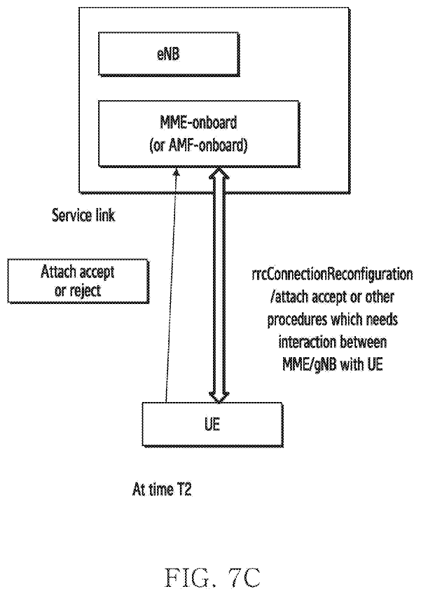

FIGS. 7A, 7B, and 7C are diagrams illustrating example scenarios of the network node interacting with the UE at various time T0, T1, and T2 respectively according to various embodiments. The Satellite has MME-onboard or AMF-onboard or any other network entity to support S&F registration/attach procedure.

In FIG. 7A (at time T0), an attach request is sent over the service link, which includes an identity request and other procedures which needs interaction between MME/gNB with UE.

In FIG. 7B (at time T1), a delete session and create session procedures (in general, all procedures which needs interactions MME/AMF onboard and other core network functions on ground) are initiated between the eNB and the core network nodes or network functions at the ground station (such as, but not limited to, UDM/HSS) over the feeder link.

In FIG. 7C (at time T2), an attach accept or reject request is sent over the service link, which includes rrcConnectionReconfiguration/attach accept or other procedures which needs interaction between the MME/gNB and the UE.

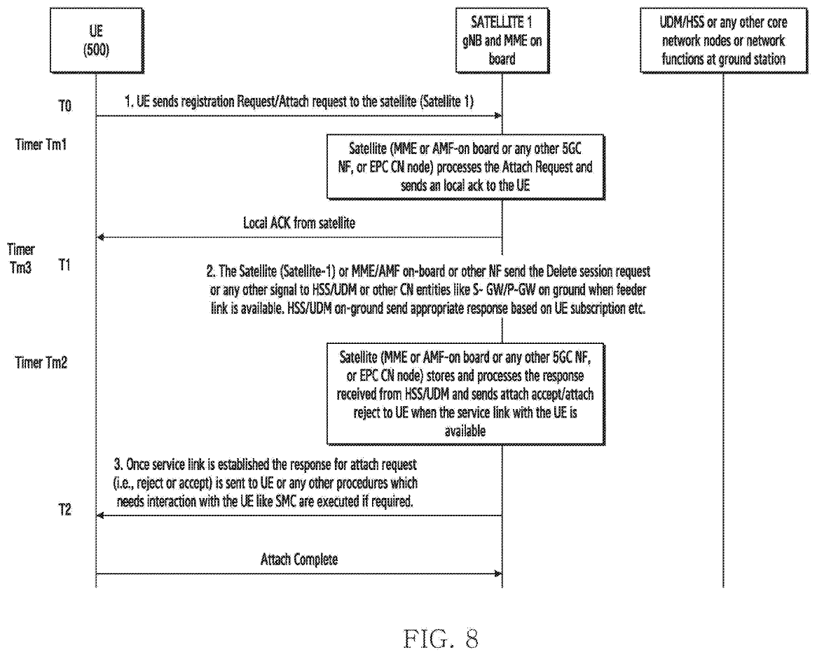

FIG. 8 is a signal flow diagram illustrating an example process of establishing a link between the UE and the satellite according to various embodiments. Consider that the UE is in a remote area with for e.g., optionally, no terrestrial networks available and the satellite serving the UE does not have feeder link available. The satellite has an

MME/AMF-onboard (or any other 5GC NF or EPC CN node onboard the satellite, while the HSS/UDM are on ground (with ground station). The Satellite and UE both support store and forward operation.

In step 1, the UE sends an attach request or registration request to the satellite At time T0. UE starts a timer (say timer Tm1), for receiving acknowledgement from the satellite. The satellite (MME/AMF onboard or any other 5GC NF or EPS CN Entity) sends an acknowledgement (in any of NAS or AS signalling message) to UE upon receiving the Attach request (or any other message or signalling) from the UE. The acknowledgement can be lower layer acknowledgement (L2 ack) or acknowledgement sent by gNB to the UE or any NAS message (sent by core network node like AMF or MME) or access stratum

(AS) message sent by gNB or eNB or NG-RAN node from satellite (e.g. onboard satellite) or indicate it is in the store and forward operation mode indicating receipt of Attach request or any other NAS message/signal from the UE. If the UE does not receive acknowledgement from satellite within timer Tm1, it attempts to send attach request or registration request again to the core network element onboard the Satellite. On receiving a local acknowledgement, the UE starts another timer (say timer Tm2). The UE waits to receive Attach Accept or Attach Reject or any other NAS message after interaction of the core network element (like MME) on board with the ground. The UE stops the timer Tm2 on receiving the response message/signal for the sent message. In an embodiment, the satellite (MME/AMF onboard or any other NF or CN entity) informs the UE, about expected time of delivery of attach request to the MME/AMF on ground and the expected response time of the next NAS message like attach accept TAU accept or authentication request or it can be any of the NAS message (for e.g. which is part of the respective procedure) to the UE. In an embodiment, the satellite informs the UE about the expected time of receipt of response (attach accept or attach reject or any other NAS message) from the MME/AMF or after interaction with ground. The UE adjusts timer Tm2 and other relevant EPS and 5GC mobility or Session management timer values based on the received information from the satellite, so that the UE doesn't attempt another attach/message/signal before receiving the response from MME/AMF or any other NF/CN node on ground. The UE may also run another timer (say Tm3) which is equal to sum of timer Tm1 and Tm2 values. The timer T3510 or T3410 can be at least one of the timers Tm1, Tm2 or Tm3.

In step 2, the Satellite or the MME/AMF-onboard or any other NF onboard the satellite processes/stores the attach request/registration request received from the UE and performs authentication and security procedures with the UE (Identity Request-Identity Response, security mode command etc.). The MME/AMF onboard the satellite then stores the required information and performs/processes procedures with the S-GW/P-GW and HSS/UDM or any other core network elements which are on the ground network (the procedures like Delete Session Request/Delete session response/update location request/create session request/create session response etc. as defined in section 5.3.2 of 3GPP TS 23.401, please refer to 23.401 for complete list) once the satellite has the feeder link available. The core network elements (e.g. AMF or MME) or the gNB which is interacting with the node on the ground station (e.g. HSS or UDM) indicates that this message is coming from onboard satellite or indicate it is in the store and forward operation mode and satellite will move away after some time, additionally the core network element will indicate the time it is available to the node on ground station, the ground station core network node will start the timer accordingly, the HSS/UDM may check if the subscription of the UE allows for such a store and forward mechanism/satellite mode of operation, HSS/UDM will provide subscription data (for example S-NSSAI related configuration or DNN/APN configuration e.g. Access and Mobility management configuration data/Session management (SM) configuration data) into the AMF/MME which is related to store and forward mechanism, based on this indication, the exact subscription data details are described in TS 23.501 and TS 23.401 respectively, the ground station node (e.g. HSS/UDM) will consider that the UE is in the store and forward operation mode. One CN node when it interacts with another CN node will indicate that the UE is in the store and forward operation in all the respective messages. Further, the core network element in ground station will increase any timer it runs considering the RTT between the HSS and the UE which involves the time to send message to node (gNB/core network element like AMF/MME) onboard+time to get the service link and interaction with the UE+time to get back the feeder link. The Satellite may optionally, run a timer say timer Tsm1 for receiving response from the S-GW/P-GW and HSS/UDM-onground. If it does not receive response from ground S-GW/P-GW and HSS/UDM, it performs the procedure with the S-GW/P-GW and HSS/UDM (or any other 5GC NF or EPS CN Node) again e.g. restarts the procedure. The nodes on the satellite may indicate to the nodes on the ground the time it will take to come back in contact with ground nodes; e.g. the round trip time as discussed in this embodiment.

The RTT time is indicated by UE to nodes (like AMF/MME/gNB) on board the satellite, The RTT is indicated by nodes (like AMF/MME/gNB) on board the satellite to the UE. The RTT is indicated by nodes (like AMF/MME/gNB) on board the satellite to the nodes on the ground station (like HSS/UDM) etc, The RTT is indicated by nodes on the ground station (like HSS/UDM) to the nodes (like AMF/MME/gNB) on board the satellite. The receiving node as described above will start the timer defined in today's standard by taking the RTT into account. The RTT time can be determined by the respective node itself without receiving from any other node. The RTT is sum of at least one of the below:
a) Time taken for UE to connect/send message to onboard nodes (like gNB or MME/AMF).
b) Time taken for satellite to re-establish feeder link
c) Time takes for service link to re-establish with the UE.

In general, when a serving satellite serves the UE, the RTT is the time taken for the satellite to take its orbit path and come back to the same location to server the UE.

In general, when a serving satellite serves the UEm the RTT is the time taken to connect to the ground station (by setting up the feeder link) and come back to serve the same UE. The RTT can be added with delta value for any potential delays.

The UE will take RTT+ any other time it may consider because of its own movement (motion) after receiving the information on RTT

In step 3, the MME/AMF onboard the satellite (or any other NF) upon receiving the response from the S-GW/P-GW and/or HSS/UDM on ground when the feeder link is available to the MME/AMF on ground (or any other 5GC NF or EPS CN Node) stores the required information with the MME/AMF (or any other entity). When the satellite reaches the location where the service link with the UE can be established, it performs the remaining procedures with the UE and exchange message/signal (rrcConnectionReconfiguration/Security procedures like Security mode command/attach accept etc.) to the UE. The UE upon receiving the response (attach accept) can send attach complete to the satellite cell (e.g., gNB and MME/AMF onboard the satellite). If the UE receives an attach reject/registration reject, the UE may attempt to perform attach procedure again or it may perform PLMN selection/cell selection/SNPN selection etc. to choose another satellite/cell to get service.

All timer values, (such as, T3410, T3450, and other timer EPS mobility management and session management timers and 5GC mobility management and session management timers mentioned in 24.501 and 24.301) should be re-adjusted considering the RTT time between UE and ground network function or core network elements (or any other 5GC NF or EPS CN Node). The RTT between the UE and MME/AMF (or any other 5GC NF or EPS CN Node) will depend on the Satellite Feeder link availability with ground station and service link availability with the UE. The timer should consider the maximum possible value from above possible values of round-trip time so that the earlier attach request is not discarded by the UE before attempting a new attach request. In an embodiment, the satellite (MME/AMF-Onboard) informs the estimated RTT (time to receive response from the core network element on ground) from ground MME/AMF. The UE adjusts the timer values considering the RTT time/expected response time (e.g. for example time to get the feeder link availability+time to get the service link availability back+optionally some delta time which can be any integer or multiples of a whole number) received from the Satellite. The timer in this embodiment is at least one of the times discussed in this embodiment.

Procedures involving s1 interface (e.g., between UE, gNB/eNB and MME/AMF) are performed when the service link is available. This involves Identity request and response and security mode command procedures. All procedures involving MME/AMF and S-GW/P-GW or HSS/UDM (e.g., deleting old session and creating new session or location update procedure) are performed at a later time when the satellite has established feeder link connection with the ground station. When the service link between the satellite and the UE is established again, the remain procedures such as rrcConnectionReconfiguration/attach accept/attach complete etc. are performed between the UE and the AMF/MME.

In an embodiment, the term satellite may refer to any of the LEO, MEO, GEO, HEO Satellites or any of the satellites.

In an embodiment, the MME/AMF onboard is used as an example. It can be any other 5GC network function (NF) or EPC CN Node or any new function. It may be with full functionality or limited functionality, to fulfil the requirement of S/F operation.

The terms satellite used in the disclosure may refer, for example, to the satellite and the NF onboard the satellite.

The term “registration procedure,” as used herein, may be associated with the registration or camping of a UE in the 5G network. The term “attach procedure” refers to the registration or camping of a UE in a 4G network or Long-Term Evolution (LTE) network. “Detach” is associated with the de-registration or detaching of a UE in a 4G Network or LTE network. The term “deregistration” is associated with the de-registration or detaching of a UE in a 5G Network or NR network.

The usage of terms “camping” or “registering” to a network or network cell may refer, for example, to the process by which a UE (e.g., a mobile phone, tablet, or similar device) connects to a specific cellular network and becomes associated with that network. It may also refer to a procedure where the UE has completed the cell/network selection/reselection process and has chosen a cell/network from which it plans to receive all available services. This can also include selecting a cell of the PLMN/network and completing necessary procedures (e.g., Location Registration) to access services from the network.

The term “Network” in the disclosure may refer to any PLMN, RAT, Access, Access Technology, Cell, Satellite, or any combination of these. The term “network” may refer to one or more of the following: a Public Land Mobile Network (PLMN), a Radio Access Technology (RAT), an access or system, a Radio Access Network (RAN), a band, a frequency, a cell, a network entity, a Core Network (CN) entity, a network function, any terrestrial network, any non-terrestrial network, or any component of the network.

In the disclosure, the network can comprise a 5G Core Network Function, such as AMF. The network can further include one or more 5G/EUTRAN Core Network Entities, which may include, but not limited to, AMF, SMF, MME, UPF, UDM, or 5G/EUTRAN RAN Entities (like eNodeB (eNB), gNodeB (gNB), or NG-RAN).

The term “network,” as used herein, may include, but are not limited to, a Public Land Mobile Network (PLMN), a Radio Access Technology (RAT), an access, a system, a Radio Access Network (RAN), a band, a frequency, a cell, a network entity, a network function, any terrestrial network, any non-terrestrial network, or any component of the network.

The term “Non-Terrestrial Network (NTN),” as used herein may include, but are not limited to, a non-terrestrial PLMN, a non-terrestrial RAT, a non-terrestrial access, a non-terrestrial system, a non-terrestrial RAN, a non-terrestrial band, a non-terrestrial frequency, a non-terrestrial cell, a non-terrestrial network entity, a non-terrestrial CN entity, a non-terrestrial network function, a component of a non-terrestrial network, a network other than a terrestrial network (TN), or a network on a satellite access network.

The term “Terrestrial Network (TN),” as used herein, may include, but are not limited to, a terrestrial PLMN, a terrestrial RAT, a terrestrial access, a terrestrial system, a terrestrial RAN, a terrestrial band, a terrestrial frequency, a terrestrial cell, a terrestrial network entity, a terrestrial CN entity, a terrestrial network function, a component of a terrestrial network, a network other than NTN, or a network other than a satellite access network.

The term “User Equipment (UE),” as used herein, may include, but are not limited to, an NTN-capable UE, a UE capable of availing NTN services, a UE supporting NTN technology, a UE capable of accessing NTN services using technologies other than NTN technology, a UE capable of availing a service deployed using a 3rd Generation Partnership Project (3GPP) satellite or NTN system, a UE capable of availing a service deployed using a 3GPP system, a UE capable of availing an NTN service deployed using any 3GPP technology, a UE capable of availing an NTN service deployed using any proprietary NTN implementation outside the scope of the 3GPP NTN system, a UE with a usage setting as a voice-centric UE, a UE configured to send or receive an Attach Type as Combined International Mobile Subscriber Identity (IMSI), or a UE configured to send or receive an Attach Type as Combined IMSI with SMS only.

The terms “camping” or “registering” to a network or network cell, as used herein, may refer, for example, to the process by which a UE (such as a mobile phone, tablet, or similar device) connects to a specific cellular network and becomes associated with that network. It may also refer to a procedure where the UE has completed the cell or network selection/reselection process and has chosen a cell or network from which it plans to receive all available services. Additionally, it may refer to the process of selecting a cell of the PLMN or network and completing any necessary procedures (e.g., Location Registration) to access services from the network.

The terms “area”, “location”, “geographical area” used in the disclosure may refer to “cell/cell ID”, “Tracking Area Code (TAC)/Tracking Area Identity (TAI)”, “Public Land Mobile Network (PLMN)”, “Mobile Country Code (MCC)/Mobile Network Code (MNC)”, “latitude/longitude”, “Closed Access Group (CAG) cell”, or “any geographical location/coordinate”.

The term ACK (or acknowledgment) may refer to NAS/Access Stratum (AS) messages as described in TS 24.501/24.301 or 36.304/38.304. For an instance, when the UE sends an Attach/Tracking Area Update (TAU) request message, the MME onboard the satellite (400) may provide an attach accept or TAU accept with the minimal context the MME/AMF is holding. The MME/AMF onboard may deliver the NAS message to the ground MME/AMF. The ground MME/AMF may start executing the procedure, and when the procedure is executed, the MME/AMF will provide the attach accept/TAU accept/registration accept message, which will have all the contents required by the UE to create the UE context.

The term “serving satellite” may refer to the satellite providing the satellite access to the UE. In the case of a Non-Geostationary Satellite Orbit (NGSO), the serving satellite may continuously change due to nature of the constellation.

According to various embodiments of the disclosure, a method performed by a user equipment (UE) for managing satellite communication using a store and forward (S&F) service with a core network node onboarding a satellite is provided. The method comprises transmitting a request message to the core network node; and receiving an accept message as a response of the request message from the core network node, the accept message including information on an estimated delivery time for data to reach a ground station from the UE; and performing a communication based on the estimated delivery time.

For example, the performing the communication comprises determining a value of a timer used to re-attempt a non-access stratum (NAS) procedure based on the estimated delivery time. The NAS procedure comprises at least one of an attach procedure, a registration procedure, a service request procedure, or a detach procedure. The timer comprises at least one of an application timer, a mobile reachability timer, a Short Message Service Control Protocol (SMS-CP) acknowledgement timer, and a Short Message Service Relay Protocol (SMS-RP) timer.

For example, the request message comprises an attach request message. The response message comprises an attach response message. The core network node comprises a mobility management entity (MME).

For example, the estimated delivery time is determined based on at least one of a current location of the UE, a number of deployed satellites, of a distance of a ground station from a UE serving area.

According to various example embodiments of the disclosure, a method performed by a core network node onboarding a satellite is provided. The method comprises receiving a request message from a user equipment (UE); and transmitting an accept message to the UE. The accept message includes information on an estimated delivery time for data to reach a ground station from the UE in accordance with at least one store and forward (S&F) operation,

For example, the method comprises determining that at least one non-access stratum (NAS) procedure initiated by a user equipment (UE) has not been completed due to at least one store and forward (S&F) operation; and based on the determination, determining the estimated delivery time.

For example, in the at least one S&F operation, the UE (500) is provided with a level of service, by at least one of storing and forwarding the data or NAS signaling for a period of time; or the satellite serving the UE reaches a geographical location through a service link.

For example, the request message comprises an attach request message. The response message comprises an attach response message. The core network node comprises a mobility management entity (MME).

For example, the core network node onboarding the satellite comprises at least one of a next generation node base station (gNB), an access and mobility management function (AMF), a mobility management entity (MME), a serving gateway (S-GW), a user plane function (UPF), a policy control function (PCF), a network exposure function (NEF), or a proxy data network (proxy-DN).

For example, the estimated delivery time is determined based on at least one of a current location of the UE, a number of deployed satellites, of a distance of a ground station from a UE serving area.

According to various example embodiments of the disclosure, a user equipment (UE) for managing satellite communication using a store and forward (S&F) service with a core network node onboard the satellite is provided. The UE comprises at least one processor including processing circuitry; and memory storing instructions that, when executed by the at least one processor, causes the UE to: transmit a request message to the core network node; receive an accept message as a response of the request message from the core network node, the accept message including information on an estimated delivery time for data to reach a ground station from the UE; and perform a communication based on the estimated delivery time.

For example, the instructions, when executed by the at least one processor, causes the UE to determine a value of a timer used to re-attempt a non-access stratum (NAS) procedure based on the estimated delivery time. The NAS procedure comprises at least one of an attach procedure, a registration procedure, a service request procedure, or a detach procedure. The timer comprises at least one of an application timer, a mobile reachability timer, a Short Message Service Control Protocol (SMS-CP) acknowledgement timer, and a Short Message Service Relay Protocol (SMS-RP) timer.

For example, the request message comprises an attach request message. The response message comprises an attach response message. The core network node comprises a mobility management entity (MME).

According to various example embodiments of the disclosure, a core network node onboarding a satellite is provided. The core network node comprises at least one processor; memory storing instructions that, when executed by the at least one processor, causes the core network node to receive a request message from a user equipment (UE); and transmit an accept message to the UE. The accept message includes information on an estimated delivery time for data to reach a ground station from the UE in accordance with at least one store and forward (S&F) operation.

For example, the request message comprises an attach request message. The response message comprises an attach response message. The core network node comprises a mobility management entity (MME).

According to various example embodiments of the disclosure a method for managing satellite communication using a store and forward (S&F) service with at least one network node onboarding a satellite (400) is provided The method comprises determining, by a User Equipment (UE) (500), that a network supports the S&F service; determining, by the UE (500), at least one new value of a timer and providing an estimated delivery time to upper layers of the UE (500), to use the at least one new value of the timer by an application layer based on at least one estimated delivery time received from a core network node (600); and initiating, by the UE (500), at least one Non-Access Stratum (NAS) procedure with the network based on the determined at least one new value of the timer.

For example, the NAS procedure comprises at least one of an attach procedure, a registration procedure, a service request procedure, and a detach procedure.

For example, the timer comprises at least one of an application timer, a mobile reachability timer, a Short Message Service Control Protocol (SMS-CP) acknowledgement timer, and a Short Message Service Relay Protocol (SMS-RP) timer.

For example, the core network node (600) onboarding the satellite (400) determines the estimated delivery time based on at least one of a current location of the UE (500), a number of deployed satellites (400), and distance of a ground station from a UE serving area.

According to various example embodiments of the disclosure, a method for managing satellite communication is provided. The method comprises determining, by a core network node (600), that at least one Non-Access Stratum (NAS) procedure initiated by a User Equipment (UE) (500) has not been completed due to at least one store and forward (S&F) operation, wherein the core network node (600) is onboard a network; and providing, by the core network node (600), at least one estimated delivery time to the UE (500) based on the determination, wherein the at least one estimated delivery time is a minimum time for a data and signaling to reach a ground station.

For example, in the at least one S&F operation, the UE (500) is provided with a level of service, by at least one of storing and forwarding the data or NAS signaling for a period of time; and the satellite (400) serving the UE (500) reaches a geographical location through a service link.

For example, the core network node (600) comprises one of a Mobility Management Entity (MME), and an Access Mobility Management Function (AMF).

For example, the core network node (600) onboarding the satellite (400) comprises at least one of a Next Generation Node B (gNB), an AMF, an MME, a Serving Gateway (S-GW), a User Plane Function (UPF), a Policy Control Function (PCF), a Network Exposure Function (NEF), and a Proxy Data Network (Proxy-DN).

According to various example embodiments of the disclosure, a User Equipment (500) for managing satellite (400) using a store and forward (S&F) service with at least one network node onboard the satellite (400) is provided, the UE (500) comprises a processor (502); and a memory (504), wherein the processor (502) is configured to determine that a network supports a S&F service; determine at least one new value of a timer and provide an estimated delivery time to upper layers of the UE (500), to use the at least one new value of the timer by an application layer based on at least one estimated delivery time received from a core network node (600); and initiate at least one Non-Access Stratum (NAS) procedure with the network based on the determined at least one new value of the timer.

For example, the NAS procedure initiated by the UE (500) comprises at least one of an attach procedure, a registration procedure, a service request procedure, and a detach procedure.

For example, the timer comprises at least one of an application timer, a mobile reachability timer, a Short Message Service Control Protocol (SMS-CP) acknowledgement timer, and a Short Message Service Relay Protocol (SMS-RP) timer.

For example, the core network node (600) onboard the satellite determines the estimated delivery time based on at least one of the locations of the UE, the number of deployed satellites (400), and distance of a ground station from the UE serving area.

According to various example embodiments, a core network node (600) for managing satellite communication is provided. The core network node (600) comprises a processor (602); a memory (604), wherein the processor (602) is configured to determine that at least one Non-Access Stratum (NAS) procedure initiated by a User Equipment (UE) (500) has not been completed due to at least one store and forward (S&F) operation, wherein the core network node (600) is onboard a network; and provide at least one estimated delivery time to the UE (500) based on the determination, wherein the at least one estimated delivery time is a minimum time for the data and signaling to reach a ground station.

For example, in the at least one S&F operation, the UE (500) is provided with a level of service, by at least one of storing and forwarding the data or NAS signaling for a period of time; and the satellite (400) serving the UE reaches a geographical location through a service link.

For example, the core network node comprises one of a Mobility Management Entity (MME), and an Access Mobility Management Function (AMF).

For example, the core network node onboard the satellite (400) comprises at least one of a Next Generation Node B (gNB), an AMF, an MME, a Serving Gateway (S-GW), a User Plane Function (UPF), a Policy Control Function (PCF), a Network Exposure Function (NEF), and a Proxy Data Network (Proxy-DN).

The various example embodiments disclosed herein can be implemented through at least one software program running on at least one hardware device and performing network management functions to control the network elements. The elements include blocks which can be at least one of a hardware device, or a combination of hardware device and software module.

It will be understood that the scope of the protection is extended to a program and in addition to a readable computer means having a message therein, such computer readable storage means contain program code means for implementation of one or more steps of the method, when the program runs on a server or mobile device or any suitable programmable device. The method may implemented through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. The disclosure may be implemented on different hardware devices, e.g., using a plurality of CPUs.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method performed by a user equipment (UE) for managing satellite communication using a store and forward (S&F) service with a core network node onboarding a satellite, the method comprising:
transmitting a request message to the core network node; and
receiving an accept message as a response of the request message from the core network node, the accept message including information on an estimated delivery time for data to reach a ground station from the UE; and
performing a communication based on the estimated delivery time.

2. The method of claim 1, wherein the performing the communication comprises:
determining a value of a timer used to re-attempt a non-access stratum (NAS) procedure based on the estimated delivery time,
wherein the NAS procedure comprises at least one of an attach procedure, a registration procedure, a service request procedure, or a detach procedure, and
wherein the timer comprises at least one of an application timer, a mobile reachability timer, a Short Message Service Control Protocol (SMS-CP) acknowledgement timer, and a Short Message Service Relay Protocol (SMS-RP) timer.

3. The method of claim 1,
wherein the request message comprises an attach request message,
wherein the response message comprises an attach response message, and
wherein the core network node comprises a mobility management entity (MME).

4. The method of claim 1, wherein the estimated delivery time is determined based on at least one of a current location of the UE or a number of deployed satellites of a distance of a ground station from a UE serving area.

5. A method performed by a core network node onboarding a satellite, the method comprising:
receiving a request message from a user equipment (UE); and
transmitting an accept message to the UE,
wherein the accept message includes information on an estimated delivery time for data to reach a ground station from the UE in accordance with at least one store and forward (S&F) operation,

6. The method of claim 5, further comprising:
determining that at least one non-access stratum (NAS) procedure initiated by a user equipment (UE) has not been completed due to at least one store and forward (S&F) operation; and
based on the determination, determining the estimated delivery time.

7. The method of claim 6,
wherein in the at least one S&F operation, the UE is provided with a level of service, by at least one of:
storing and forwarding the data or NAS signaling for a period of time; or
the satellite serving the UE reaches a geographical location through a service link.

8. The method of claim 5,
wherein the request message comprises an attach request message,
wherein the response message comprises an attach response message, and
wherein the core network node comprises a mobility management entity (MME).

9. The method of claim 5, wherein the core network node onboarding the satellite comprises at least one of a next generation node base station (gNB), an access and mobility management function (AMF), a mobility management entity (MME), a serving gateway (S-GW), a user plane function (UPF), a policy control function (PCF), a network exposure function (NEF), or a proxy data network (proxy-DN).

10. The method of claim 5, wherein the estimated delivery time is determined based on at least one of a current location of the UE or a number of deployed satellites of a distance of a ground station from a UE serving area.

11. A user equipment (UE) for managing satellite communication using a store and forward (S&F) service with a core network node onboard the satellite, the UE comprising:
at least one processor comprising processing circuitry; and
memory storing instructions, wherein the instructions, when executed by the at least one processor individually or collectively, cause the UE to:
transmit a request message to the core network node;
receive an accept message as a response of the request message from the core network node, the accept message including information on an estimated delivery time for data to reach a ground station from the UE; and
perform a communication based on the estimated delivery time.

12. The UE of claim 11, wherein the instructions, when executed by the at least one processor, cause the UE to:
determine a value of a timer used to re-attempt a non-access stratum (NAS) procedure based on the estimated delivery time,
wherein the NAS procedure comprises at least one of an attach procedure, a registration procedure, a service request procedure, or a detach procedure, and
wherein the timer comprises at least one of an application timer, a mobile reachability timer, a Short Message Service Control Protocol (SMS-CP) acknowledgement timer, or a Short Message Service Relay Protocol (SMS-RP) timer.

13. The UE of claim 11,
wherein the request message comprises an attach request message,
wherein the response message comprises an attach response message, and
wherein the core network node comprises a mobility management entity (MME).

14. The UE of claim 11, wherein the estimated delivery time is determined based on at least one of a current location of the UE or a number of deployed satellites of a distance of a ground station from a UE serving area.
